(19) United States
(12) Patent Application Publication
(10) Pub. No.: US 2023/0182456 A1
(43) Pub. Date: Jun. 15, 2023

(54) BUILDING PANEL AND METHOD TO PRODUCE SUCH PANEL

(71) Applicant: Valinge Innovation AB, Viken (SE)

(72) Inventors: Per JOSEFSSON, Ramlösa (SE); Filip SKÖLD, Löddeköpinge (SE)

(73) Assignee: Valinge Innovation AB, Viken (SE)

(21) Appl. No.: 18/063,822

(22) Filed: Dec. 9, 2022

(30) Foreign Application Priority Data
Dec. 10, 2021 (SE) 2151509-3

(51) Int. Cl. B32B 27/12; B32B 7/12; B32B 27/08; B32B 27/34; B32B 27/36; B32B 7/02; B32B 37/12; B32B 37/18

(52) U.S. Cl. CPC B32B 27/12; B32B 7/12; B32B 27/08; B32B 27/34; B32B 27/36; B32B 7/02; B32B 37/1207; B32B 37/185; B32B 2471/02; B32B 2377/00; B32B 2367/00; B32B 2037/1215; B32B 2305/22; B32B 2274/00

(57) ABSTRACT

A building panel having a substrate and a layer arrangement, arranged on one side of the substrate. The layer arrangement having a surface layer and where the surface layer includes carpet fibres. At least the substrate at least partly includes a mechanical locking device for connecting at least two building panels. Where the substrate and the layer arrangement each includes a polymer of the same type of polymer.

### CROSS REFERENCE TO RELATED APPLICATIONS

The present application claims the benefit of Swedish Application No. 2151509-3, filed on Dec. 10, 2021. The entire contents of Swedish Application No. 2151509-3 are hereby incorporated herein by reference in their entirety.

### TECHNICAL FIELD

The invention relates to building panels, more specifically to floor panels, and methods of producing such panels.

### BACKGROUND

Flooring with a carpet-like surface provides a soft and warm feeling when stepping on it which is probably why it is popular to install into homes and other spaces. It also provides indefinite possibilities regarding the design of the flooring and any colour or pattern may be incorporated into the flooring. However, these types of carpet flooring may be quite difficult to handle and install for a person not being a professional installer, as they often come on large and heavy rolls. Further, these types of carpet flooring may be difficult to remove and nearly impossible to replace smaller areas of the flooring. For instance, if one area of the flooring has been worn down more than others it might be desirable to not having to replace the entire carpet flooring but just the worn-down area. Further, when the flooring is worn down or damaged it has been difficult to handle and recycle due to the heavy and often large size of the carpet flooring and to the often laminated structure which may then result in usable material being thrown away and/or destroyed.

It is a desire to produce more sustainable and environmentally conscious flooring that contributes to reduced material resource use, improve material recycling, prolong the life of carpet flooring, and reduce waste of material.

### SUMMARY

An object of the inventive concept is to provide improvements over known art.

Another object of the inventive concept is to provide a completely recyclable building panel. In the same recycling process step, without separating the layer of the building panel.

Yet another object of the inventive concept is to provide a totally recyclable building panel which is easy to install, remove and exchange.

Another object of the inventive concept is to provide a building panel which prolongs the life of the flooring and reduce the waste of material.

Additionally, it is an object of the inventive concept to provide a method for producing such building panels.

In a first aspect of the inventive concept there is provided a building panel including a substrate, a layer arrangement, arranged on one side of the substrate. The layer arrangement includes a surface layer and where the surface layer comprises decorative carpet fibres. Further, the substrate comprises a substrate binder including a polymer and the layer arrangement comprises a layer arrangement binder including a polymer, where the polymer of the substrate binder and the polymer of the layer arrangement binder is the same type of polymer, and where layer(s) and the decorative carpet fibres of the layer arrangement each comprises the same type of polymer. The same type of polymer is to be interpreted as having the same type of polymer as base polymer. E.g., if one has PVC as its base polymer, they all have PVC as their base polymer, or if one has polyester as its base polymer, they all have polyester as their base polymer, and so on.

In an embodiment the polymer is the majority polymer in polymer(s) of the substrate binder, and the polymer is the majority polymer in polymer(s) of the layer arrangement binder.

The building panel may comprise a front side and a rear side. The front side may be a visible side of the panel and the rear side may be concealed in an installed state of the panel, such as facing a subfloor, a sub roof, or a sub wall.

The building panel may have any type of shape in order to create a desirable design of the panel system. Rectangular, triangular, square, puzzle-like, or any other type of connectable shapes are equally possible.

Further, the building panel comprises a mechanical locking device. The mechanical locking device is configured to assemble and lock a plurality of building panels together to form a panel system. Depending on the desirable shape of each building panel different types of mechanical locking devices may be used.

In an embodiment, at least the substrate, at least partly, includes the mechanical locking device for connecting two or more building panels.

The mechanical locking device may be configured for horizontal and vertical locking of similar or essentially identical building panels. Such building panels may be assembled by means of a horizontal displacement, a vertical displacement and/or a folding displacement. By similar or essentially identical building panels are meant the structural and/or mechanical features of the building panels and not necessary the visual or decorative features of the building panel.

An advantage with the building panel is that it is essentially completely recyclable without having to take apart the components of the building panel and sort them according to material as the entire building panel is made from materials chosen to include the same type of polymer or essentially the same type of polymer. Therefore, no separation of material is needed which make the building panel easy to recycle.

A recycling process starts with disassembling the panel system, alternatively disassembling individual building panels from the panel system, and gathering the individual building panel/-s to be recycled. The building panel/-s is then taken to, e.g., a shredder to cut the building panel/-s into smaller pieces, e.g., granulates. If desirable, the pieces may be extracted from the recycling process already in this stage. If it is desirable to have even smaller pieces, e.g., flakes or the like, the shredded material may be processed further by a grinder. Further, a plurality of grinders, strainers and/or separators may be used to produce any desirable sizes of the material, e.g., from powder to granulates. The recycled material is then ready to be re-used for, e.g., producing new building panels.

Further, the building panel with its mechanical locking device is easily connected to another similar or essentially identical building panel. Consequently, a complete flooring or other type of decorative surface may easily be installed due to the mechanical locking device.

As said above, the substrate and the layer arrangement each comprise a binder, the substrate binder, and the layer arrangement binder each comprising the same type of polymer or essentially the same type of polymer. For example, the substrate binder and the layer arrangement binder may each comprise 10 to 100 wt % of the same type of polymer. For example, each may comprise 10 to 100 wt % of a polystyrene polymer. By having a common binder including the same type of polymer the building panel with all its components, or at least all components that are integrally formed, can be recycled simultaneously without having to separate the components and/or layers before the recycling process.

In an embodiment, the substrate binder includes a substrate polymer, wherein at least 60 wt %, or at least 80 wt %, or at least 90 wt %, or all of the substrate polymer may be a common binder. The layer arrangement binder includes a layer arrangement polymer, wherein at least 60 wt %, or at least 80 wt %, or at least 90 wt %, or all of the layer arrangement polymer may be the common binder.

In an embodiment, the substrate comprises an amount of more than 10 wt % or more than 15 wt % of the binder, up to 100 wt %. In an embodiment, the substrate comprises an amount of more than 10 wt % or more than 15 wt % of a polymer up to 100 wt %.

Further, the layer arrangement may comprise an amount of more than 40 wt % or more than 50 wt % of the binder, up to 100 wt %. Further, the layer arrangement may comprise an amount of more than 40 wt % or more than 50 wt % of a polymer, up to 100 wt %.

In an embodiment, the polymer of the binder is thermoplastic.

In an embodiment, the polymer is a fossil-based polymer.

In an embodiment, the polymer is a bio-based polymer. Bio-based polymers are made from renewable sources, such as plants, such as corn-starch or bagasse, algae, bacteria etc.

The polymer of the binder chosen for the substrate and the layer arrangement may be chosen from polyester, polyvinyl chloride, polypropylene, or polyamide.

Examples of suitable polyester are PET and PTT.

Examples of suitable polyamide are PA 6 and PA 66.

The substrate may further comprise an organic filler, an inorganic filler, or a combination thereof. Examples of organic fillers are wood fibres, cellulose fibres, natural fibres, carbon fibres, and bamboo. Examples of inorganic fillers are calcium carbonate, chalk, talc, limestone, fly ash, silica, or perlite. The filler may be a functional filler. For example, the functional filler may increase the rigidity of the core.

The substrate may further comprise at least one additive(s). An additive may be a plasticizer, pigment, or a process additive.

The substrate may have a thickness of between 1 and 8 mm.

The substrate may have a single layer structure or a multi-layer structure.

A multi-layer structured substrate may be a substrate having, e.g., a balancing layer arranged within the substrate or in the bottom of the substrate.

Another example of a multi-layer structured substrate may be a substrate having a softer or more flexible layer arranged on a top surface and/or bottom surface of a centre layer. This may be advantageous if it is desirable to have a building panel which provides a softer feel and/or decreased noise when walking on it.

Yet another example of a multi-layer structured substrate may be a substrate having a harder or more rigid layer arranged on a top surface and/or bottom surface of a centre layer. This may be advantageous if it is desirable to have a building panel which provides a protection for a softer centre layer.

The layer arrangement may further include a carrier to which the carpet fibres are attached. The carrier comprises the same type of polymer as the substrate and the decorative carpet fibres. The carrier may be uniform and solid or partly open, e.g., a grid-shape to allow carpet fibres to be attached by means of different types of known techniques. Know techniques of arranging and/or attaching carpet fibres are, e.g., loop pile, cut pile, a combination or loop and cut pile, tufted fibres, woven fibres, or needle punched fibres.

The surface layer, or at least the carpet fibres, may, throughout an assembled panels system, differ in order to create a desirable design, e.g., different patterns, changing colours, text or other type of design features.

The layer arrangement may further include an adhesive layer, arranged between the substrate and the rest of the layer arrangement, adhering the rest of the layer arrangement to the substrate. In an embodiment the adhesive layer is arranged between the substrate and the surface layer for adhering the surface layer to the substrate, or to any other desirable layer arranged in between the surface layer and the substrate.

The amount of adhesive applied between the substrate and the rest of the layer arrangement is more than 10 g/m², preferably more than 30 g/m² or even more preferably more than 50 g/m² and, optionally, up to 500 g/m².

The optional adhesive layer comprises the same type of polymer as the substrate binder and the decorative carpet fibres.

The adhesive may be or comprise a glue. The glue comprises the same type of polymer, or essentially the same type of polymer, as the binder of the substrate and the binder of the rest of the layer arrangement.

In an embodiment the polymer of the glue is thermoplastic.

In an embodiment the polymer is a fossil-based polymer.

In an embodiment the polymer is a bio-based polymer. Bio-based polymers are made from renewable sources such as plants, such as corn-starch or bagasse, algae, bacteria etc.

The adhesive may be or comprise a hot melt. The hot melt comprises the same type of polymer, or essentially the same type of polymer, as the binder of the substrate and the binder of the rest of the layer arrangement.

In an embodiment the polymer of hot melt is thermoplastic.

In an embodiment the polymer is a fossil-based polymer.

In an embodiment the polymer is a bio-based polymer. Bio-based polymers are made from renewable sources such as plants, such as corn-starch or bagasse, algae, bacteria, etc.

A hot melt may be advantageous to use if a higher wt % of the chosen polymer is desirable to have. A hot melt may mostly comprise of thermoplastic material, which may be desirable since the components of the building panel is made of one type of polymer, preferably thermoplastic, as explained above, throughout the building panel. A hot melt can be solvent free which is a further positive feature regarding handling and environmental aspects.

In an alternative embodiment the building panel may include an adhering area between the substrate and the layer arrangement. Material from the surface of the substrate facing the layer arrangement and material from the surface of the layer arrangement facing the substrate may at least partly merged with each other in the adhering area. Such an adhering area may be done through a hot lamination process.

Alternatively, merging the material of the substrate and the layer arrangement may be done through a chemical welding process.

Such a chemical welding process may comprise:
applying a solvent on the surface of the substrate, facing the layer arrangement, and/or on the surface of the layer arrangement, facing the substrate, before arranging the layer arrangement on the substrate, to create adhesion between the substrate and layer arrangement. The solvent may be chosen from any one of: Tetrahydrofuran (THF), Acetone and/or Cyclohexane.

The carpet fibres may be in the form of loop pile, cut pile, a combination of loop and cut piles, tufted fibres, woven fibres, or needle punched fibres.

In an embodiment there may be provided an optional second layer arrangement, arranged on the other side of the substrate, on the lower side of the substrate, opposite the first layer arrangement with the carrier and the surface layer, as defined above. The optional lower layer arrangement may serve as a balancing layer and may impact the balancing properties and/or the stability of the building panel. As described above, the balancing layer may already be incorporated in the substrate, in a multi-layer structure, which leaves the second layer arrangement unnecessary.

The upper and the optional lower layer arrangements comprise the same type of binder with the same type of polymer or essentially the same type of polymer. By having a binder including the same type of polymer the building panel with all its components can be recycled simultaneously without having to separate the components before the recycling process.

In an embodiment the polymer of the binder is thermoplastic.

In an embodiment the polymer is a fossil-based polymer.

In an embodiment the polymer is a bio-based polymer. Bio-based polymers are made from renewable sources such as plants, such as corn-starch or bagasse, algae, bacteria, etc.

The binder of the lower layer arrangement is preferably the same as the binder of the substrate and the upper layer arrangement, where the polymer of the binder may be chosen from polyester, polyvinyl chloride, polypropylene, or polyamide.

Examples of suitable polyester are PET and PTT.

Examples of suitable polyamide are PA 6 and PA66.

The lower layer arrangement may comprise an amount of more than 10 wt % or more than 15 wt % of the chosen binder, up to 100 wt % binder. In an embodiment, the lower layer arrangement may comprise an amount of more than 10 wt %, or more than 15 wt % of a polymer up to 100 wt %.

The lower layer arrangement may have a single layer structure.

The lower layer arrangement may have a multi-layer structure.

As said above, the building panel comprises a mechanical locking device. The mechanical locking device may include connecting means. In order to assemble a plurality of building panels each building panel may comprise connecting means and counter-connecting means, where connecting means of a first building panel is assembled with a counter-connecting means of an adjacent second building panel.

In an embodiment where the building panel is shaped with essentially straight edges, such as a square, triangular or a rectangular shape, the mechanical locking device may have a first pair of connecting means and/or a second pair of connecting means, are arranged on of opposite side edges of the building panel. In order to assemble a plurality of building panels, the first pair and/or second pair of connecting means include connecting means and counter connecting means configured to be compatible with one another.

In an example, if the building panel has a rectangular shape, it may be beneficial to have a first pair of connecting means on opposite long side edges of the building panel and a second pair of connecting means on opposite short side edges of the building panel. However, if the building panel has a square or triangular shape, it may be beneficial to have only one type, e.g., the first pair, of connecting means arranged around the building panel.

The connecting means of the mechanical locking device arranged along one side edge of the building panel may be compatible with the counter-connecting means arranged along the opposite side edge of the building panel. In this way, it is easy to know how to assemble a plurality of building panels.

The connecting means and counter-connecting means of the mechanical locking device may comprise, for a horizontal locking, a locking element and a locking element groove for receiving the locking element, where the locking element is provided along a side edge of a building panel and the locking element groove is provided along a side edge of an adjacent building panel.

Alternatively, or additionally, the locking element and locking element groove may comprise locking surfaces configured to cooperate also for vertical locking of two adjacent building panels.

The connecting means and counter-connecting means of the mechanical locking device may further comprise, for a vertical locking, a tongue and a tongue groove for receiving the tongue, where the tongue is provided along a side edge of a building panel and the tongue groove is provided along a side edge of an adjacent building panel.

Alternatively, or additionally, the tongue and tongue groove may comprise locking surfaces configured to cooperate also for horizontal locking of two adjacent building panels.

In a first example, the tongue is integrally formed with the side edge of the building panel, preferably with the side edge of the substrate of the building panel. This is conceivable on all types of side edges of all types of building panels.

In a second example, and as may preferred on a shorter side edge, e.g., short sides of a rectangular shaped building panel, a displaceable tongue, separately formed from the rest of the mechanical locking device, is provided to create horizontal and/or vertical locking of two adjacent building panels. The displaceable tongue may be configured to be received in a displacement tongue groove provided in the side edge of the building panel and arranged within the displacement tongue groove before assembling two building panels.

The tongue groove or the displaceable tongue groove may extend in a horizontal direction of the building panel, preferably along the entire extension of the side edge of the building panel.

The mechanical locking device may partly be arranged in the substrate and partly arranged in the layer arrangement.

The area in which the mechanical locking device are arranged have a vertical height of at least 2 mm, more preferably more than 3 mm, or even more preferably more than 3.5 mm and up to, for example, 10 or 20 mm.

The substrate may have an E-modulus of at least 300 MPa, between 300 MPa and 12,000 MPa, or between 500 MPa and 10,000 MPa, measured according to ISO178:2010/A1:2013. Having an E-module of at least 300 MPa allows to create and use any desirable mechanical locking device.

The building panel may have a plurality of grooves arranged on the rear surface of the substrate and/or building panel. The plurality of grooves may be arranged in a homogenous pattern. Published document WO 2020/197475 illustrate building panels having pluralities of grooves which are all possible embodiments of the present inventive concept.

The substrate may have a plurality of grooves provided in an upper side of the substrate.

In accordance with a second aspect of the inventive concept, there is provided a building panel comprising a substrate, and a layer arrangement, arranged on one side of the substrate, where the layer arrangement comprises a surface layer and wherein the surface layer comprises decorative carpet fibres. Further, at least the substrate comprises a mechanical locking device arranged at least partly along at least one side edge of the building panel and configured to connect similar or essentially identical building panels in an assembled position. Yet further, the substrate comprises a polymer and the decorative fibres comprises a polymer, where the polymer of the substrate and the polymer of the decorative carpet fibres each are of the same type of polymer, and where layer(s) and the decorative carpet fibres included in the layer arrangement each comprises the same type of polymer.

In an embodiment the polymer is a thermoplastic polymer.

In another embodiment the polymer is chosen from polyester, polyvinyl chloride, polypropylene, or polyamide.

The surface layer may further comprise a carrier to which the decorative carpet fibres are attached, wherein the carrier comprises a polymer which is the same type of polymer as the substrate and the decorative carpet fibres.

Further, the layer arrangement may comprise an adhesive layer, arranged between the substrate and the surface layer where the adhesive layer comprises the same type of polymer as the substrate and the decorative carpet fibres.

In an embodiment the adhesive layer is or comprises a glue.

In another embodiment the adhesive layer is or comprises a hot melt.

In yet another embodiment the building panel further comprising an adhering area between the substrate and the surface layer, where material from the surface of the substrate facing the surface layer, and material from the surface of the surface layer facing the substrate may at least partly merged with each other in the adhering area.

In an embodiment the merge of the surfaces of the substrate and the surface layer is accomplished by a chemical welding process.

In another embodiment the merge of the surfaces of the substrate and the surface layer is accomplished by a lamination process.

The decorative carpet fibres may further be arranged according to a loop pile technique, a cut pile technique, a combination of a loop pile and a cut pile technique, as tufted fibres, woven fibres and/or needle punched fibres.

Further, the mechanical locking device may comprise connecting means arranged at least partly along at least one side edge of the building panel, and counter-connecting means arranged at least partly along at least one side edge of the building panel, wherein the connecting means and the counter-connecting means are arranged on opposite side edges of the building panel, and wherein the connecting means is configured to engage with a counter-connecting means of at least a second building panel.

In an embodiment, the connecting means and the counter-connecting means are configured to lock at least two adjacent building panels in a substantially horizontal and/or vertical direction.

In a third aspect of the inventive concept there is provided a set of panels comprising a plurality of building panels in accordance with any of the aspects, embodiments or examples of the first aspect. The details and advantages as well as embodiments and examples of the third aspect are largely analogous to those of the first and/or second aspect, wherein reference is made thereto.

In accordance with a fourth aspect of the inventive concept, there is provided a method of producing a building panel comprising:
providing a substrate,
applying a surface layer comprising a carrier and decorative carpet fibres, on the substrate,
applying an adhesive layer on the surface of the substrate facing the carrier and/or on the surface of the surface layer facing the substrate before applying the surface layer on the substrate,

wherein the substrate, the adhesive layer, and the surface layer, comprising the carrier and the decorative carpet fibres, each comprise the same type of polymer, or essentially the same type of polymer,
applying pressure to the substrate and/or the surface layer to form the building panel,
creating mechanical locking device in at least the substrate, before or after applying pressure to form the building panel, wherein the mechanical locking device is configured to connecting at least two building panels.

The substrate and the layer arrangement each preferably comprise a binder, also called the substrate binder and the layer arrangement binder, each comprises the same type of polymer or essentially the same type of polymer. Essentially the same type of polymer is to be interpreted as having the same type of polymer as base polymer. E.g., if one has PVC as its base polymer, they all have PVC as their base polymer, or if one has polyester as its base polymer, they all have polyester as their base polymer, and so on.

For example, the substrate binder and the layer arrangement binder may each comprise 10 to 100 wt % of the same type of polymer. For example, each may comprise 10 to 100 wt % of a polystyrene polymer.

In an embodiment the polymer is the majority polymer in polymer(s) of the substrate binder, and the polymer is the majority polymer in polymer(s) of the layer arrangement binder.

By having a common binder including the same type of polymer the building panel with all its components, or at least all integrally formed components, can be recycled simultaneously without having to separate the components and/or layers before the recycling process. In an embodiment the polymer of the binder and the adhesive is thermoplastic.

In an embodiment the polymer is a fossil-based polymer.

In an embodiment the polymer is a bio-based polymer. Bio-based polymers are made from renewable sources such as plants, such as corn-starch or bagasse, algae, bacteria, etc.

The binder chosen for the substrate and the surface layer, and the adhesive, includes a polymer chosen from polyester, polyvinyl chloride, polypropylene, or polyamide.

Examples of suitable polyester are PET and PTT.

Examples of suitable polyamide are PA6 or PA66.

In an embodiment, the substrate binder includes a substrate polymer, wherein at least 60 wt %, or at least 80 wt %, or at least 90 wt %, or all of the substrate polymer may be a common binder. The layer arrangement binder includes a layer arrangement polymer, wherein at least 60 wt %, or at least 80 wt %, or at least 90 wt %, or all of the layer arrangement polymer may be the common binder.

In an embodiment, the substrate comprises an amount of more than 10 wt % or more than 15 wt % of the binder, up to 100 wt %. In an embodiment, the substrate comprises an amount of more than 10 wt % or more than 15 wt % of a polymer up to 100 wt %.

Further, the layer arrangement may comprise an amount of more than 40 wt % or more than 50 wt % of the binder, up to 100 wt %. Further, the layer arrangement may comprise an amount of more than 40 wt % or more than 50 wt % of a polymer, up to 100 wt %.

The substrate may comprise an organic filler, an inorganic filler, or a combination thereof. Examples of organic fillers are wood fibres, cellulose fibres, natural fibres, carbon fibres, and bamboo. Examples of inorganic fillers are calcium carbonate, chalk, talc, limestone, fly ash, silica, or perlite.

The filler may be a functional filler. For example, the functional filler may increase the rigidity of the core.

The substrate may further comprise at least one additive(s). An additive may be a plasticizer, pigment, or a process additive.

The substrate may have a thickness of between 1 and 8 mm.

The substrate may have a single layer structure or a multi-layer structure.

A multi-layer structured substrate may be a substrate having, e.g., a balancing layer arranged within the substrate or in the bottom of the substrate.

Another example of a multi-layer structured substrate may be a substrate having a softer or more flexible layer arranged on a top surface and/or bottom surface of a centre layer. This may be advantageous if it is desirable to have a building panel which provides a softer feel and/or decreased noise when walking on it. The hardness may be measured, e.g., by means of ISO 868:2003, Shore A or Shore B.

Yet another example of a multi-layer structured substrate may be a substrate having a harder or more rigid layer arranged on a top surface and/or bottom surface of a centre layer. This may be advantageous if it is desirable to have a building panel which provides a protection for a softer centre layer. The hardness may be measured, e.g., by means of ISO 868:2003, Shore A or Shore B.

The carrier may be uniform and solid or partly open, e.g., a grid-shape to allow carpet fibres to be attached by means of different types of known techniques. Know techniques of arranging and attaching carpet fibres are, e.g., loop pile, cut pile, a combination or loop and cut pile, tufted fibres, woven fibres, or needle punched fibres.

The carpet fibres may preferably be attached to the carrier.

The carpet fibres may preferably be pre-attached to the carrier prior to the method of producing the building panel.

The carpet fibres may be in the form of loop pile, cut pile, a combination of loop and cut piles, tufted fibres, woven fibres, or needle punched fibres.

The surface layer, or at least the carpet fibres, may, throughout an assembled panels system, differ in order to create a desirable design, e.g., different patterns, changing colours, text or other type of design features.

The adhesive, arranged between the substrate and the carrier, adheres the carrier with the surface layer to the substrate.

The amount of adhesive applied between the substrate and the rest of the layer arrangement is more than 10 g/m², preferably more than 30 g/m² or even more preferably more than 50 g/m² and, optionally, up to 500 g/m².

The adhesive may be a glue. The glue is chosen to include the same type of polymer, or essentially the same type of polymer, as the binder of the substrate and the binder of the rest of the layer arrangement.

In an embodiment the polymer of the glue is thermoplastic.

In an embodiment the polymer is a fossil-based polymer.

In an embodiment the polymer is a bio-based polymer. Bio-based polymers are made from renewable sources such as plants, such as corn-starch or bagasse, algae, bacteria, etc.

The adhesive may be a hot melt. The hot melt comprises the same type of polymer, or essentially the same type of polymer, as the binder of the substrate and the binder of the rest of the layer arrangement.

In an embodiment the polymer of the hot melt is thermoplastic.

In an embodiment the polymer is a fossil-based polymer.

In an embodiment the polymer is a bio-based polymer. Bio-based polymers are made from renewable sources such as plants, such as corn-starch or bagasse, algae, bacteria, etc.

A hot melt may be advantageous to use if a higher wt % of the chosen polymer is desirable to have. A hot melt may mostly comprise of thermoplastic material, which may be desirable since the components of the building panel is made of one type of polymer, preferably thermoplastic, as explained above, throughout the building panel. A hot melt can be solvent free which is a further positive feature regarding handling and environmental aspects.

The adhesive, the carrier, and the surface layer are included in a layer arrangement, also called an upper layer arrangement.

The mechanical locking device is configured to assemble and lock a plurality of building panels together to form a panel system. Depending on the desirable shape of each building panel different types of mechanical locking devices may be used.

In an embodiment, the mechanical locking device is created in the substrate.

The mechanical locking device may be configured for horizontal and vertical locking of similar or essentially identical building panels. Such building panels may be assembled by means of a horizontal displacement, a vertical displacement and/or a folding displacement. By similar or essentially identical building panels are meant the structural and/or mechanical features of the building panels and not necessary the visual or decorative features of the building panel.

The mechanical locking device may include connecting means. In order to assemble a plurality of building panels each building panel may comprise connecting means and counter-connecting means, where connecting means of a first building panel is assembled with a counter-connecting means of an adjacent second building panel.

In an embodiment where the building panel is shaped with essentially straight edges, such as a square, triangular or a rectangular shape, the mechanical locking device may have a first pair of connecting means and/or a second pair of connecting means, are arranged on of opposite side edges of the building panel. In order to assemble a plurality of building panels, the first pair and/or second pair of connecting means include connecting means and counter connecting means configured to be compatible with one another.

In an example, if the building panel has a rectangular shape, it may be beneficial to have a first pair of connecting means on opposite long side edges of the building panel and a second pair of connecting means on opposite short side edges of the building panel. However, if the building panel has a square or triangular shape, it may be beneficial to have only one type, e.g., the first pair, of connecting means arranged around the building panel.

The connecting means of the mechanical locking device arranged along one side edge of the building panel may be compatible with the counter-connecting means arranged along the opposite side edge of the building panel. In this way, it is easy to know how to assemble a plurality of building panels.

The connecting means and counter-connecting means of the mechanical locking device may comprise, for a horizontal locking, a locking element and a locking element groove for receiving the locking element, where the locking element is provided along a side edge of a building panel and the locking element groove is provided along a side edge of an adjacent building panel.

Alternatively, or additionally, the locking element and locking element groove may comprise locking surfaces configured to cooperate also for vertical locking of two adjacent building panels.

The connecting means and counter-connecting means of the mechanical locking device may further comprise, for a vertical locking, a tongue and a tongue groove for receiving the tongue, where the tongue is provided along a side edge of a building panel and the tongue groove is provided along a side edge of an adjacent building panel.

Alternatively, or additionally, the tongue and tongue groove may comprise locking surfaces configured to cooperate also for horizontal locking of two adjacent building panels.

In a first example, the tongue is integrally formed with the side edge of the building panel, preferably with the side edge of the substrate of the building panel. This is conceivable on all types of side edges of all types of building panels.

In a second example, and as may preferred on a shorter side edge, e.g., short sides of a rectangular shaped building panel, a displaceable tongue, separately formed from the rest of the mechanical locking device, is provided to create horizontal and/or vertical locking of two adjacent building panels. The displaceable tongue may be configured to be received in a displacement tongue groove provided in the side edge of the building panel and arranged within the displacement tongue groove before assembling two building panels.

An advantage with the building panel is that it is essentially completely recyclable without having to take apart the components of the building panel and sort them according to material as the entire building panel is made from material including the same type of polymer, or essentially the same type of polymer. Therefore, no separation of material is needed which make the building panel easy to recycle.

A recycling process starts with disassembling the panel system, alternatively disassembling individual building panels from the panel system, and gathering the individual building panel/-s to be recycled. The building panel/-s is then taken to, e.g., a shredder to cut the building panel/-s into smaller pieces, e.g., granulates. If desirable, the pieces may be extracted from the recycling process already in this stage. If it is desirable to have even smaller pieces, e.g., flakes or the like, the shredded material may be processed further by a grinder. Further, a plurality of grinders, strainers and/or separators may be used to produce any desirable sizes of the material, e.g., from powder to granulates. The recycled material is then ready to be re-used for. e.g., producing new building panels.

The method may further comprise:
applying heat to the substrate and/or the surface layer when applying pressure to form the building panel.

The method may further comprise:
applying cold to the substrate and/or surface layer when applying pressure to form the building panel.

The step of creating mechanical locking device may comprise creating the mechanical locking device in only the substrate.

The step of creating mechanical locking device may further comprise partly creating the mechanical locking device in the substrate and partly creating the mechanical locking device in the carrier.

The step of creating mechanical locking device may further comprise creating a mechanical locking area, in which the mechanical locking device is provided, in the substrate and/or the carrier with a vertical height of at least 2 mm, more preferably more than 3 mm, or even more preferably more than 3.5 mm and, optionally, up to 15 mm.

The method may further comprise:
applying a balancing layer arrangement on the substrate, opposite the carrier and the surface layer, before applying pressure to form the building panel,

wherein the balancing layer arrangement comprises a binder including the same type of polymer, or essentially the same type of polymer, as the substrate, the carrier, the surface layer, and the adhesive.

The balancing layer arrangement may be called a lower layer arrangement.

The balancing layer arrangement will serve as a balancing layer and may impact the balancing properties and/or the stability of the building panel. As described above, the balancing layer may already be incorporated in the substrate, in a multi-layer structure, which leaves the second layer arrangement unnecessary.

The binder of the lower layer arrangement may include a polymer chosen from polyester, polyvinyl chloride, polypropylene, or polyamide.

Examples of suitable polyester are PET or PTT.

Examples of suitable polyamide are PA6 or PA66.

The lower layer arrangement may have a single layer structure.

The lower layer arrangement may have a multi-layer structure.

In accordance with a fifth aspect of the inventive concept, there is provided a method of producing a building panel comprising:
providing a substrate,
applying a layer arrangement, wherein the layer arrangement comprises a surface layer which at least partly comprises carpet fibres, on the substrate,
creating adhesion between the substrate and the layer arrangement,

wherein the substrate and the layer arrangement each comprise a binder including the same type of polymer, or essentially the same type of polymer,
applying pressure to the substrate and/or the layer arrangement to form the building panel,
creating mechanical locking device in at least the substrate, before or after applying pressure to form the building panel, wherein the mechanical locking device is configured for connecting at least two building panels.

The substrate and the layer arrangement each comprise a binder, also called the substrate binder and the layer arrangement binder each comprising the same type of polymer or essentially the same type of polymer. Essentially the same type of polymer is to be interpreted as having the same type of polymer as base polymer. E.g., if one has PVC as its base polymer, they all have PVC as their base polymer, or if one has polyester as its base polymer, they all have polyester as their base polymer, and so on.

For example, the substrate binder and the layer arrangement binder may each comprise 10 to 100 wt % of the same type of polymer. For example, each may comprise 10 to 100 wt % of a polystyrene polymer.

In an embodiment the polymer is the majority polymer in polymer(s) of the substrate binder, and the polymer is the majority polymer in polymer(s) of the layer arrangement binder.

By having a common binder including the same type of polymer the building panel with all its components, or at least all integrally formed components, can be recycled simultaneously without having to separate the components and/or layers before the recycling process.

In an embodiment the polymer of the binder is thermoplastic.

In an embodiment the polymer is a fossil-based polymer.

In an embodiment the polymer is a bio-based polymer. Bio-based polymers are made from renewable sources such as plants, such as corn-starch or bagasse, algae, bacteria etc.

The binder of the substrate and the binder of the layer arrangement includes a polymer chosen from polyester, polyvinyl chloride, polypropylene, or polyamide.

Examples of suitable polyester are PET or PTT.

Examples of suitable polyamide are PA6 or PA66.

In an embodiment, the substrate binder includes a substrate polymer, wherein at least 60 wt %, or at least 80 wt %, or at least 90 wt %, or all of the substrate polymer may be a common binder. The layer arrangement binder includes a layer arrangement polymer, wherein at least 60 wt %, or at least 80 wt %, or at least 90 wt %, or all of the layer arrangement polymer may be the common binder.

In an embodiment, the substrate comprises an amount of more than 10 wt % or more than 15 wt % of the binder, up to 100 wt %. In an embodiment, the substrate comprises an amount of more than 10 wt % or more than 15 wt % of a polymer up to 100 wt %.

Further, the layer arrangement may comprise an amount of more than 40 wt % or more than 50 wt % of the binder, up to 100 wt %. Further, the layer arrangement may comprise an amount of more than 40 wt % or more than 50 wt % of a polymer, up to 100 wt %.

The substrate may further comprise an organic filler, an inorganic filler, or a combination thereof. Examples of organic fillers are wood fibres, cellulose fibres, natural fibres, carbon fibres, and bamboo. Examples of inorganic fillers are calcium carbonate, chalk, talc, limestone, fly ash, silica, or perlite.

The filler may be a functional filler. For example, the functional filler may increase the rigidity of the core. This may be measured, e.g., by means of ISO 868:2003, Shore A or Shore B.

The substrate may further comprise at least one additive(s). An additive may be a plasticizer, pigment, or a process additive.

The substrate may have a thickness of between 1 and 8 mm.

The substrate may have a single layer structure or a multi-layer structure.

A multi-layer structured substrate may be a substrate having, e.g., a balancing layer arranged within the substrate or in the bottom of the substrate.

Another example of a multi-layer structured substrate may be a substrate having a softer or more flexible layer arranged on a top surface and/or bottom surface of a centre layer. This may be advantageous if it is desirable to have a building panel which provides a softer feel and/or decreased noise when walking on it.

Yet another example of a multi-layer structured substrate may be a substrate having a harder or more rigid layer arranged on a top surface and/or bottom surface of a centre layer. This may be advantageous if it is desirable to have a building panel which provides a protection for a softer centre layer.

The layer arrangement may comprise a carrier and a surface layer which is arranged on the carrier, where the surface layer at least partly comprises carpet fibres.

The carpet fibres may preferably be attached to the carrier.

The carpet fibres may preferably be pre-attached to the carrier prior to the method of producing the building panel.

The carrier may be uniform and solid or partly open, e.g., a grid-shape to allow carpet fibres to be attached by means of different types of known techniques. Know techniques of arranging and attaching carpet fibres are, e.g., loop pile, cut pile, a combination or loop and cut pile, tufted fibres, woven fibres, or needle punched fibres.

The carpet fibres may be in the form of loop pile, cut pile, a combination of loop and cut piles, tufted fibres, woven fibres, or needle punched fibres.

The surface layer, or at least the carpet fibres, may, throughout an assembled panels system, differ in order to create a desirable design, e.g., different patterns, changing colours, text or other type of design features.

The step of creating adhesion between the substrate and the layer arrangement may comprise:
merging material from the surface of the substrate facing the layer arrangement and material from the surface of the layer arrangement facing the substrate.

The merging of the material of the substrate and the layer arrangement may be made through a chemical welding process.

The step of creating adhesion may further comprise:
applying a solvent on the surface of the substrate, facing the layer arrangement, and/or on the surface of the layer arrangement, facing the substrate, before arranging the layer arrangement on the substrate, to create adhesion between the substrate and layer arrangement.

The solvent may be chosen from any one of: Tetrahydrofuran (THF), Acetone and/or Cyclohexane.

The merging the material of the substrate and the surface layer may be made through a lamination process.

The mechanical locking device is configured to assemble and lock a plurality of building panels together to form a panel system. Depending on the desirable shape of each building panel different types of mechanical locking devices may be used.

In an embodiment, the mechanical locking device is created in the substrate.

The mechanical locking device may be configured for horizontal and vertical locking of similar or essentially identical building panels. Such building panels may be assembled by means of a horizontal displacement, a vertical displacement and/or a folding displacement. By similar or essentially identical building panels are meant the structural and/or mechanical features of the building panels and not necessary the visual or decorative features of the building panel.

The mechanical locking device may include connecting means. In order to assemble a plurality of building panels each building panel may comprise connecting means and counter-connecting means, where connecting means of a first building panel is assembled with a counter-connecting means of an adjacent second building panel.

In an embodiment where the building panel is shaped with essentially straight edges, such as a square, triangular or a rectangular shape, the mechanical locking device may have a first pair of connecting means and/or a second pair of connecting means, are arranged on of opposite side edges of the building panel. In order to assemble a plurality of building panels, the first pair and/or second pair pf connecting means include connecting means and counter connecting means configured to be compatible with one another.

In an example, if the building panel has a rectangular shape, it may be beneficial to have a first pair of connecting means on opposite long side edges of the building panel and a second pair of connecting means on opposite short side edges of the building panel. However, if the building panel has a square or triangular shape, it may be beneficial to have only one type, e.g., the first pair, of connecting means arranged around the building panel.

The connecting means of the mechanical locking device arranged along one side edge of the building panel may be compatible with the counter-connecting means arranged along the opposite side edge of the building panel. In this way, it is easy to know how to assemble a plurality of building panels.

The connecting means and counter-connecting means of the mechanical locking device may comprise, for a horizontal locking, a locking element and a locking element groove for receiving the locking element, where the locking element is provided along a side edge of a building panel and the locking element groove is provided along a side edge of an adjacent building panel.

Alternatively, or additionally, the locking element and locking element groove may comprise locking surfaces configured to cooperate also for vertical locking of two adjacent building panels.

The connecting means and counter-connecting means of the mechanical locking device may further comprise, for a vertical locking, a tongue and a tongue groove for receiving the tongue, where the tongue is provided along a side edge of a building panel and the tongue groove is provided along a side edge of an adjacent building panel.

Alternatively, or additionally, the tongue and tongue groove may comprise locking surfaces configured to cooperate also for horizontal locking of two adjacent building panels.

In a first example, the tongue is integrally formed with the side edge of the building panel, preferably with the side edge of the substrate of the building panel. This is conceivable on all types of side edges of all types of building panels.

In a second example, and as may preferred on a shorter side edge, e.g., short sides of a rectangular shaped building panel, a displaceable tongue, separately formed from the rest of the mechanical locking device, is provided to create horizontal and/or vertical locking of two adjacent building panels. The displaceable tongue may be configured to be received in a displacement tongue groove provided in the side edge of the building panel and arranged within the displacement tongue groove before assembling two building panels.

An advantage with the building panel is that it is essentially completely recyclable without having to take apart the components of the building panel and sort them according to material as the entire building panel is made from material chosen from the same type of polymer, or essentially the same type of polymer. Therefore, no separation of material is needed which make the building panel easy to recycle.

A recycling process starts with disassembling the panel system, alternatively disassembling individual building panels from the panel system, and gathering the individual building panel/-s to be recycled. The building panel/-s is then taken to, e.g., a shredder to cut the building panel/-s into smaller pieces, e.g., granulates. If desirable, the pieces may be extracted from the recycling process already in this stage. If it is desirable to have even smaller pieces, e.g., flakes or the like, the shredded material may be processed further by a grinder. Further, a plurality of grinders, strainers and/or separators may be used to produce any desirable sizes of the material, e.g., from powder to granulates. The recycled material is then ready to be re-used for e.g., producing new building panels.

Further, the building panel with its mechanical locking device is easily connected to another similar or essentially identical building panel. Consequently, a panel system, e.g., a complete flooring or other type of decorative surface, may easily be installed due to the mechanical locking device.

The method may further comprise:
applying heat to the substrate and/or the surface layer when applying pressure to form the building panel.

The method may further comprise:
applying cold to the substrate and/or surface layer when applying pressure to form the building panel.

The step of creating mechanical locking device may comprise creating the mechanical locking device in only the substrate.

The step of creating mechanical locking device may further comprise partly creating the mechanical locking device in the substrate and partly creating the mechanical locking device in the layer arrangement.

The step of creating mechanical locking device may further comprise creating a mechanical locking area, in which the mechanical locking device is provided, in the substrate and/or the layer arrangement with a vertical height of at least 2 mm, more preferably more than 3 mm, or even more preferably more than 3.5 mm.

The method may further comprise:
applying a balancing layer arrangement on the substrate, opposite the other layer arrangement, having the carpet fibres, before applying pressure to form the building panel,

wherein the balancing layer arrangement comprises a binder including the same type of polymer, or essentially the same type of polymer, as the substrate, and the other layer arrangement.

The balancing layer arrangement will impact the balancing properties and/or the stability of the building panel. As described above, the balancing layer may already be incorporated in the substrate, in a multi-layer structure, which leaves the second layer arrangement unnecessary.

The balancing layer arrangement may be called a lower layer arrangement and the other layer arrangement, with the carpet fibres, may be called the upper layer arrangement.

The upper layer arrangement, the lower layer arrangement and the substrate may comprise the same type of binder. The polymer of the binder may be chosen from polyester, polyvinyl chloride, polypropylene, or polyamide.

Examples of suitable polyester are PET or PTT.

Examples of suitable polyamide are PA6 or PA66.

The lower layer arrangement may have a single layer structure.

The lower layer arrangement may have a multiple layer structure.

The building panel may be manufactured in a lamination process.

### BRIEF DESCRIPTION OF THE DRAWINGS

Embodiments of the invention will be described in the following: reference being made to the appended drawings which illustrate non-limiting embodiments of how the inventive concept can be reduced into practice.

FIGS. 1a and 1b,are schematic illustrations of a side view of a building panel according to an embodiment of the inventive concept with two different surface layers,

FIG. 2, is a schematic illustration of a top view of a building panel according to an embodiment of the inventive concept,

FIGS. 3a-3c are schematic illustrations of different types of surface layers for a building panel according to the inventive concept,

FIGS. 4a-4c illustrate a first mechanical locking device for a building panel according to an embodiment of the inventive concept and the installation of two such building panels,

FIGS. 5a-5c illustrate a second mechanical locking device for a building panel according to an embodiment of the inventive concept and the installation of two such building panels,

FIG. 6 illustrates a displaceable locking tongue, according to an embodiment, to be arranged in a mechanical locking device illustrated in FIGS. 5a-5c,

FIG. 7 illustrates a top view of a building panel illustrated in FIG. 5a with the displaceable locking tongue,

FIGS. 8a-8c illustrate a third mechanical locking device for a building panel according to an embodiment of the inventive concept and an assemble of two such building panels,

FIGS. 9a-9c illustrated the third mechanical locking device for another building panel according to an embodiment of the inventive concept and as assemble of two such building panels

FIG. 10 illustrates a schematical cross section of a building panel according to an embodiment of the inventive concept,

FIG. 11 illustrates a rear side of the building panel in FIG. 10,

FIG. 12 illustrates a plurality of building panels according to an embodiment of the inventive concept, attached and arranged to form a panel system,

FIG. 13 illustrates a plurality of building panels according to an embodiment of the inventive concept, attached and arrange to form a panel system,

FIG. 14 illustrates a plurality of building panels according to an embodiment of the inventive concept, attached and arranged to form a panel system, and

FIGS. 15a-15c schematically illustrate methods to produce a building panel according to an embodiment of the inventive concept.

### DETAILED DESCRIPTION OF EMBODIMENTS

With reference to the drawings a building panel 1 is disclosed. The building panel 1 may be a floor panel, a wall panel, a door panel, a ceiling panel, or a furniture component. The building panel 1 may have any desirable shape but is mostly illustrated with a substantially square or rectangular shape. The building panel 1 is configured to form a piece of a panel system, such as a flooring, and to be connected to other similar or essentially identical building panels 1. The plurality of building panels may be assembled by means of a horizontal displacement, a vertical displacement and/or a folding displacement.

Each building panel 1, as illustrated in FIG. 2, has four sides 2a-2d, where two sides 2a, 2c may be longer than the other sides 2b, 2d. Each side has a side edge 3a-3d. In order to explain the features of the building panels 1 each side edge 3a-3d has an upper portion 5a-5d, an intermediate portion 6a-d and a lower portion 7a-d. The upper portion 5a-d is closest to the surface layer 21, the lower portion 7a-d are opposite the upper portion 5a-d farthest away from the surface layer 21, and the intermediate portion 6a-d are in between the upper portion 5a-d and the lower portion 7a-d.

The building panel 1 includes a substrate 10 and a layer arrangement 20 which is arranged on one side of the substrate 10.

The substrate 10 may have a thickness of at least 2 mm, more preferably more than 3 mm, or even more preferably more than 3.5 mm.

The substrate 10 is illustrated as a single layer substrate but may in alternative embodiments be a multi-layer substrate.

The substrate 10 has a first surface 11a and a second surface 11b, which in the figures are illustrated as an upper surface 11a and a lower surface 11b. The layer arrangement 20 is attached to the upper surface 11a.

Optionally, the building panel may include another layer arrangement (not shown) attached to other opposite side of the substrate. The building panel may then have an upper layer arrangement and a lower layer arrangement, where the upper layer arrangement is arranged on the upper side of the substrate and the lower layer arrangement is arranged on the lower side of the substrate. The optional lower layer arrangement may be configured to serve as a balancing layer for the building panel.

In an embodiment the balancing feature is incorporated in the substrate, e.g., in a multi-layered substrate.

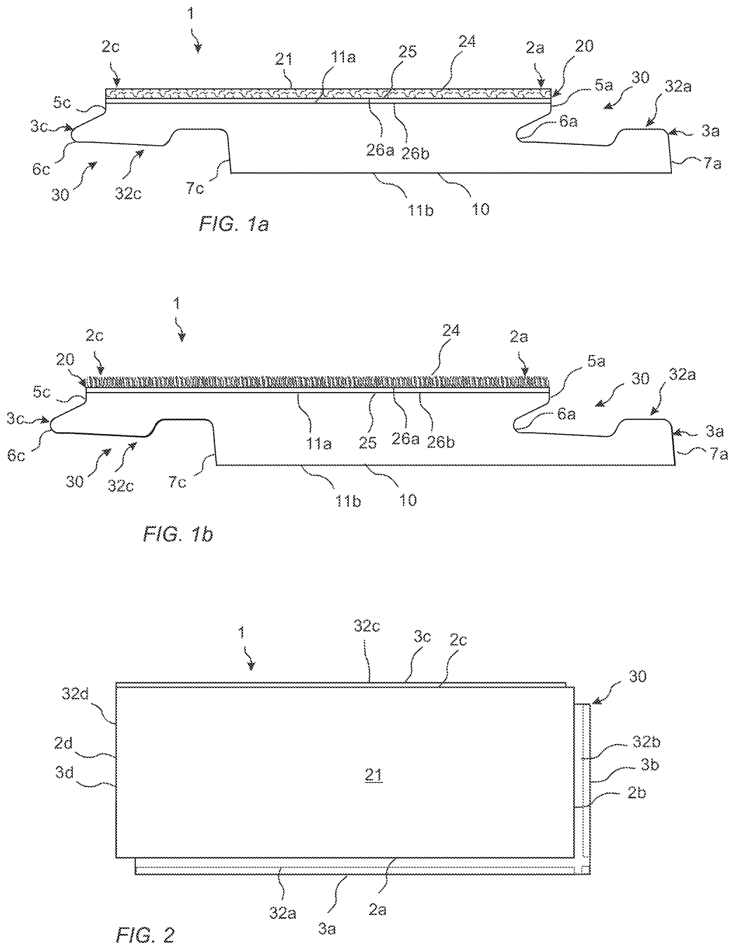

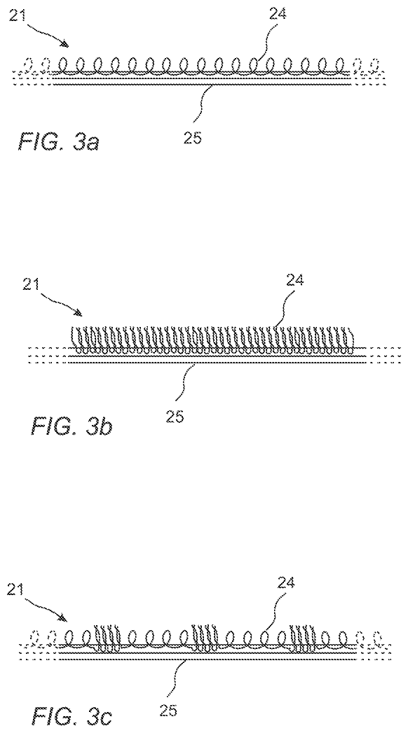

The layer arrangement 20, as illustrated in FIGS. 1a and 1b, includes a surface layer 21, which in turn comprises a carrier 25 and a decorative layer 24. The decorative layer of the surface layer 21 is formed by decorative carpet fibres 24. The decorative carpet fibres 24 may be arranged in any suitable known way in order to create any desirable pattern, softness, or design. FIG. 1a schematically illustrate carpet fibres arranged in a woven design. FIG. 1B schematically illustrate carpet fibres arranged in a cut design. Known ways to arrange and create a decorative layer with carpet fibres are by, e.g., a loop pile technique, a cut pile technique, a combination of those two techniques, as tufted fibres, as woven fibres or as needle punched fibres. Schematic illustrations of techniques can be seen in FIGS. 3a-3c, where FIG. 3a illustrates loop pile, FIG. 3b illustrates cut pile and FIG. 3c illustrates a combination of loop pile and cut pile. The technique and arrangement of the carpet fibres may, throughout an assembled panels system, differ in order to create a desirable design, e.g., different patterns, changing colours, text or other type of design features.

The carpet fibres 24 are attached to the carrier 25 according to any of the known techniques. The carrier 25 may have a uniform, solid shape or a uniform and partly open shape, e.g., a grid-shape. The carpet fibres 24 may then be attached, sewn, or woven into the carrier 25.

The carrier 25 is configured to carry the carpet fibres 24 on one side 26a and be attached to the substrate 10, or any desirable layer arranged between the surface layer 21 and the substrate 10, on the opposite side 26b.

The layer arrangement 20 further includes an adhesive layer 28 arranged between the substrate 10 and the surface layer 21. In the illustrated embodiment the adhesive layer 28 is arranged between the substrate 10 and the carrier 25. The adhesive layer 28 is configured to adhere the surface layer 21 to the substrate 10, or to any desirable layer arranged between the surface layer 21 and the substrate 10.

The adhesive layer 28 may be or comprise a glue. Alternatively, the adhesive layer may be or comprise a hot melt.

The amount of adhesive applied between the substrate 10 and the rest of the layer arrangement 20 is more than 10 g/m², preferably more than 30 g/m² or even more preferably more than 50 g/m².

In an alternative embodiment, the building panel may comprise an adhering area between the substrate and the layer arrangement. Material from the surface of the substrate, facing the layer arrangement, and the material from the surface of the layer arrangement, e.g., the surface of the carrier, facing the substrate, are at least partly merged with each other in the adhering area. The merge of the surfaces of the substrate and the layer arrangement may be accomplished by a chemical welding process. Alternatively, the merge of the surface of the substrate and the layer arrangement may be accomplished by a hot lamination process. In such a lamination process material from both surfaces may be sticky to be able to adhere to each other. Alternatively, in such a lamination process material from both surfaces may be softened to be able to adhere to each other. Alternatively, in such a lamination process material from both surfaces may be at least partly melted to be able to mix and merge with each other.

The substrate 10 and the layer arrangement 20 comprise the same type of polymer, or essentially the same type of polymer. That means that all components and layers of the layer arrangement 20 includes the same type of polymer. Included in the layer arrangement 20 is at least the surface layer 21, i.e., the carpet fibres 24 and the carrier 25, and optionally at least one adhesive layer 28. The polymer is preferably included in a binder of each layer, where the rest of each layer may include, e.g., fillers, pigments, and other additives.

The polymer of the substrate 10 and the layer arrangement 20 may be thermoplastic. The polymer may be a fossil-based polymer, or the polymer may be a bio-based polymer. Bio-based polymers are made from renewable sources such as plants, such as corn-starch or bagasse, algae, bacteria etc.

The polymer of the substrate and the layer arrangement is chosen from polyester, polyvinyl chloride, polypropylene, or polyamide. Thus, the polymer of both the substrate 10 and layer arrangement 20 may either be polyester, or polyvinyl chloride, or polypropylene, or polyamide.

An advantage with these types of polymers is that they are all compatible with each layer, i.e., may be present in substrates, in adhesives, in carpet fibres and carriers, even though these types of different components of a building panel have different properties when it comes to, e.g., design, durability, manufacturing, etc.

As mentioned above, the building panel further includes a mechanical locking device 30 for connecting at least two adjacent building panels 1, 1′. The mechanical locking device 30 may be configured for horizontal and vertical locking of similar or essentially identical building panels 1. Such building panels 1 may be assembled by means of a horizontal displacement, a vertical displacement and/or a folding displacement.

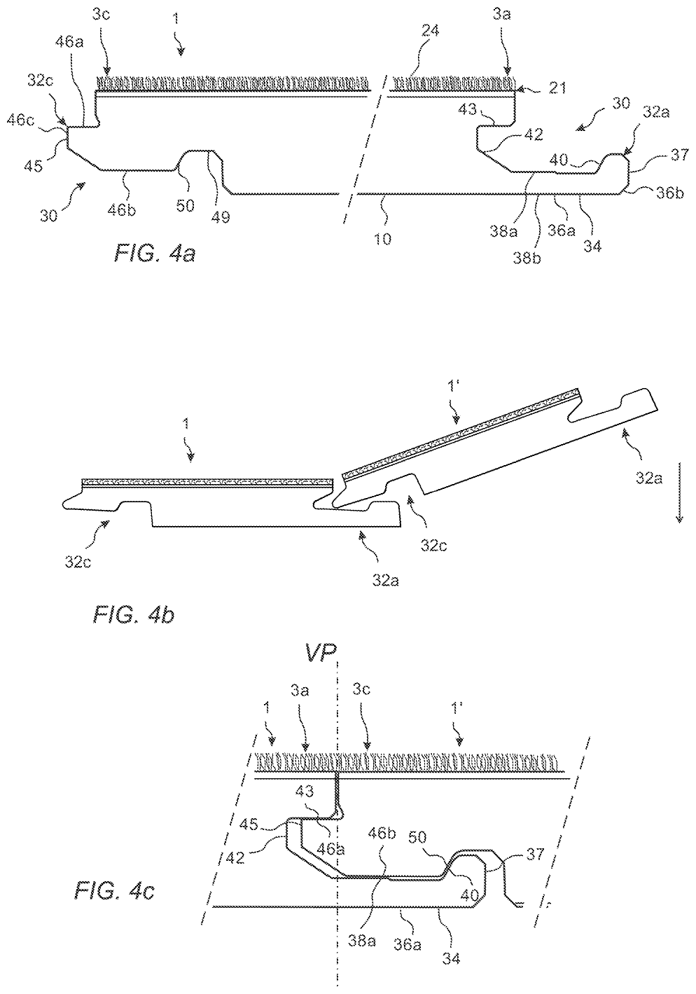

As illustrated in, e.g., FIG. 4b, each building panel 1 has a mechanical locking device 30. The mechanical locking device 30 is arranged in the side edge 3a, 3c, 3c, 3d of the building panel 1. The mechanical locking device 30 extends, at least partly but preferably continuously, along the extension of the side edge 3a, 3b, 3c, 3d in which it is arranged.

The area in which the mechanical locking device 30 is arranged have a vertical height of at least 2 mm, more preferably more than 3 mm, or even more preferably more than 3.5 mm.

FIG. 4a illustrates a building panel 1 having the mechanical locking device 30 including a first pair of connecting means, from now on called connecting means 32a and counter-connecting means 32c. The connecting means 32a and counter-connecting means 32c are arranged along two opposite sides edges 3a, 3c of the building panel 1. FIG. 4a illustrates connecting means 32a and counter-connecting means 32c which are often provided in the side edges 3a, 3c of the longer sides 2a, 2c of the building panel 1, if the building panel has a rectangular shape. These type of connecting means 32a and counter-connecting means 32c may of course also be provided in the other side edges, e.g., in the short sides 2b, 2d of the building panel 1, being of a rectangular shape. These type of connecting means and counter connecting means may also be preferred if building panels having a square or triangular shape.

The connecting means and counter-connecting means extend, at least partly but preferably continuously, along the extension of the side edge in which it is arranged.

In order to be able to connect two building panels 1, 1′ it is preferred to provide the compatible connecting means 32a and counter-connecting means 32c on opposite sides of the building panels 1. In an alternative embodiment (not shown), for example when having a triangular shaped building panel having no opposite sides, a first building panel may be provided with the connecting means of the first pair and the second adjacent building panel may be provided with the counter-connecting means of the first pair.

The connecting means 32a and counter-connecting means 32c are provided substantially in the substrate 10 of the building panel 1. In alternative embodiments the connecting means and counter-connecting means may be provided in both the substrate and in the layer arrangement.

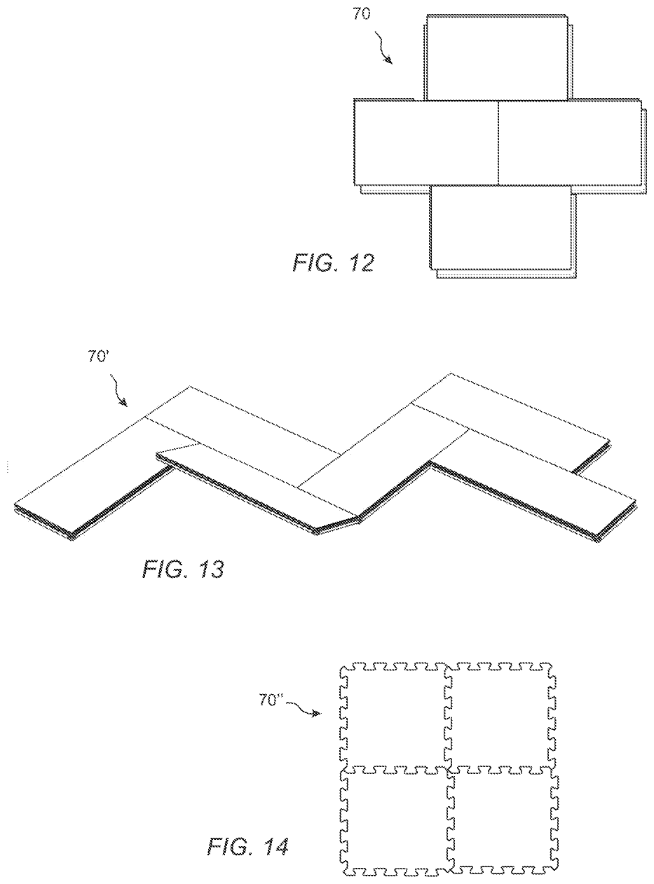

The connecting means 32a is provided in the first side edge 3a of the building panel 1. The counter-connecting means 32c is provided in an opposite third side edge of the building panel 1. The connecting means 32a and counter-connecting means 32c are configured to horizontally and/or vertically lock a plurality of building panels 1 in an assembled state, where examples of assembled building panels are illustrated in FIGS. 12, 13 and 14. The connecting means 32a and counter-connecting means 32c are designed to engage with each other such that the horizontal and/or vertical locking may be achieved.

In the illustrated example, the connecting means 32a includes a strip 34 extending horizontally beyond the upper portion 5a of the side edge 3a. The strip 34 is formed in the substrate 10 in the lower portion 7a of the building panel 1. Since the substrate 10 and in turn the strip 34 is preferably made of a polymer material, the strip 34 is preferably flexible. An advantage with having a flexible strip is that the risk of damaging or breaking the strip during locking of the building panel to an adjacent panel may be reduced. Additionally, the mechanical locking device and hence the building panel may become more resistant to heavy loads.

The strip 34 may extend outwardly from a vertical plane VP defined by immediately juxtaposed upper portions 5a, 5c of two neighboring joint side edges 3a, 3c of two joined panels 1, 1′ as illustrated in FIG. 4c.

The strip 34 is integrated with the substrate 10.

The strip 34 extends, at least partly but preferably continuously, along the extension of the side edge in which it is arranged.

The strip 34 includes an intermediate portion 36a and a locking element 37. The locking element 37 is arranged at an outermost end portion 36b of the strip 34. The intermediate portion 36a extends, from an innermost end portion towards the locking element 37, in a horizontal direction away from the side edge 3a of the building panel 1. The intermediate portion 36a may be oblong.

A lower side 38b of the intermediate portion 36a is preferably integrated with an in level with the lower surface 11b of the substrate 10. An upper side 38a of the intermediate portion 36a is designed to receive a lower surface 46b of a locking tongue 45 of the counter-connecting means 32c of a side edge 3c of an adjacent building panel 1′ in an assembled position. The upper side 38a of the intermediate portion 36a is configured to at least partly cooperate with the lower surface 46b of the locking tongue 45 of the counter-connecting means 32c in the assembled position, as illustrated in FIG. 4c. The upper side 38a of the intermediate portion 36a is configured to at least partly be in contact with the lower surface 46b of the locking tongue 45 in the assembled position.

The locking element 37 is preferably integrated with the rest of the strip 34. The locking element 37 is preferably integrated with the intermediate portion 36a of the strip 34. The locking element 37 is configured to be received in a locking element groove 49 of the counter-connecting means 32c of the adjacent building panel 1′.

The locking element 37 includes a locking surface 40 which is configured to lock two connected building panels 1, 1′ in a vertical and/or horizontal direction. The locking surface 40 is configured to lock two building panels 1, 1′ such that they are not able to be displaced, or move away from each other, in the assembled position. In the illustrated example the locking surface 40 is angled in relation to the horizontal and vertical axis. The locking surface 40 faces in towards the side edge 3a of the building panel 1.

The locking surface 40 is configured to cooperate with a rear locking surface 50 of a locking tongue 45 of the counter-connecting means 32c in the assembled position, as illustrated in the FIG. 4c. The locking surface 40 of the locking element 37 is configured to at least partly be in contact with the rear locking surface 50 of the locking tongue 45, in the assembled position.

The connecting means 32a further includes a tongue groove 42 arranged in the intermediate portion 6a of the side edge 3a. The tongue groove 42 substantially extends inwards in the horizontal direction.

The tongue groove 42 extends inwardly from the vertical plane VP defined by immediately juxtaposed upper portions 5a, 5c of two neighboring joint side edges 3a, 3c of two joined panels 1, 1′ as illustrated in FIG. 4c.

The tongue groove 42 is arranged in the substrate 10.

The tongue groove 42 extends, at least partly but preferably continuously, along the extension of the side edge in which it is arranged.

The tongue groove 42 is configured to receive a locking tongue 45 of the counter-connecting means 32c in the assembled position. An upper wall 43 of the tongue groove 42 is configured to vertically lock the locking tongue 45. The upper wall 43 of the tongue groove 42 is configured to cooperate with an upper surface 46a of the locking tongue 45 in order to guide the locking tongue 45 in the locking groove 42 and to create the vertical locking.

The counter-connecting means 32c includes the locking tongue 45. The locking tongue 45 is arranged in the intermediate portion 6c of the side edge 3c of the panel 1.

The locking tongue 45 is arranged in the substrate 10 of the building panel 1. The locking tongue 45 is preferably integrated with the substrate 10.

The locking tongue 45 extends, at least partly but preferably continuously, along the extension of the side edge in which it is arranged.

The locking tongue 45 includes an upper surface 46a facing upwards towards the surface layer 21 and a lower surface 46b facing downwards towards the back of the building panel 1. The upper surface 46a is configured to cooperate, and preferably engage, with the upper wall 43 of the tongue groove 42 of the adjacent building panel 1. Together, the upper surface 46a of the locking tongue 45 and the upper wall 43 of the tongue groove 42 vertically lock the adjacent building panels 1, 1′ in the assembled position. The lower surface 46b may be configured to cooperate, and preferably at least partly engage, with the upper side 38a of the intermediate portion 36a of the strip 34 of the adjacent building panel 1.

The locking tongue 45 further has a front surface 46c facing out from the side edge 3c of the building panel 1. The front surface 46c is configured to be received in the tongue groove 42 of the adjacent building panel 1 in the assembled position.

The counter-connecting means 32c further includes the locking element groove 49 which is arranged in the intermediate portion 6c and lower portion 7c of the side edge 3c of the building panel 1. The locking element groove 49 is configured to receive the locking element 37 of the connecting means 32a of the adjacent building panel 1.

The locking element groove 49 extends, at least partly but preferably continuously, along the extension of the side edge in which it is arranged.

The locking element groove 49 includes a front surface 50 which is configured to cooperate, and preferably engage, with the locking surface 40 of the locking element 37 of the adjacent building panel 1 in the assembled position. The front surface 50 is configured to horizontally and/or vertically lock the locking element 37.

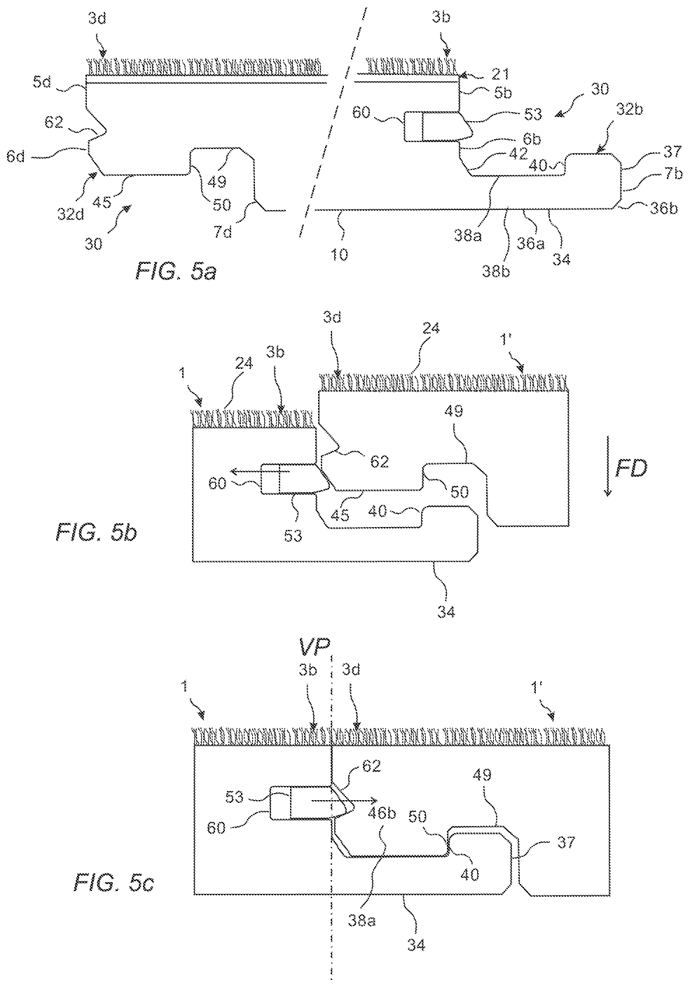

FIG. 5a illustrates a building panel 1 having the mechanical locking device 30 including a second pair of connecting means, from now on called connecting means 32b and counter-connecting means 32d.

The connecting means 32b and counter-connecting means 32d are arranged along two opposite sides edges 3b, 3d of the building panel 1. FIG. 5a illustrates connecting means 32b and counter-connecting means 32d which are often provided in the side edges 3b, 3d of the shorter sides 2b, 2d of the building panel 1, if the building panel has a rectangular shape. These type of connecting means 32b and counter-connecting means 32d may of course also be provided in the other side edges, e.g., in the long sides 2a, 2c of the building panel 1, being of a rectangular shape. These type of connecting means and counter connecting means may also be preferred if the building panels have a square or triangular shape.

The connecting means and counter-connecting means extend, at least partly but preferably continuously, along the extension of the side edge in which it is arranged.

In order to be able to connect two building panels 1, 1′ it is preferred to provide the compatible connecting means 32b and counter-connecting means 32d on opposite sides of the building panels 1.

The connecting means 32b and counter-connecting means 32d are provided substantially in the substrate 10 of the building panel 1. In alternative embodiments the connecting means and counter-connecting means may be provided in both the substrate and in the layer arrangement.

The connecting means 32b is provided in the second side edge 3b of the building panel 1. The counter-connecting means 32d is provided in an opposite fourth side edge of the building panel 1. The connecting means 32b and counter-connecting means 32d are configured to horizontally and/or vertically lock a plurality of building panels 1, 1′ in an assembled state, where examples of assembled building panels are illustrated in FIGS. 12, 13 and 14. The connecting means 32b and counter-connecting means 32d are designed to engage with each other such that the horizontal and/or vertical locking may be achieved.

In the illustrated example, the connecting means 32b includes a strip 34 extending horizontally beyond the upper portion 5b of the side edge 3b. The strip 34 is formed in the substrate 10 in the lower portion 7b of the building panel 1. Since the substrate 10 and in turn the strip 34 is made of a polymer material, the strip 34 is preferably flexible. An advantage with having a flexible strip is that the risk of damaging or breaking the strip during locking of the building panel to an adjacent panel may be reduced. Additionally, the mechanical locking device and hence the building panel may become more resistant to heavy loads.

The strip 34 may extend outwardly from a vertical plane VP defined by immediately juxtaposed upper portions 5b, 5d of two neighboring joint side edges 3b, 3d of two joined panels 1, 1′ as illustrated in FIG. 5c.

The strip 34 is integrated with the substrate 10.

The strip 34 extends, at least partly but preferably continuously, along the extension of the side edge in which it is arranged.

The strip 34 includes an intermediate portion 36a and a locking element 37. The locking element 37 is arranged at an outermost end portion 36b of the strip 34. The intermediate portion 36a extends, from an innermost end portion towards the locking element 37, in a horizontal direction away from the side edge 3b of the building panel 1. The intermediate portion 36a may be oblong and extend out from the side edge 3a in an essentially horizontal direction in an assembled position, between the tongue groove 42 and the locking element 37.

A lower side 38b of the intermediate portion 36a is preferably integrated in level with the lower surface 11b of the substrate 10. An upper side 38a of the intermediate portion 36a is designed to receive a lower surface 46b of a locking tongue 45 of the counter-connecting means 32d of a side edge 3d of an adjacent building panel 1′ in an assembled position. The upper side 38a of the intermediate portion 36a is configured to at least partly cooperate with the lower surface 46b of the locking tongue 45 of the counter-connecting means 32d in the assembled position, as illustrated in FIG. 5c. The upper side 38a of the intermediate portion 36a is configured to at least partly be in contact with the lower surface 46b of the locking tongue 45 in the assembled position.

The locking element 37 is preferably integrated with the rest of the strip 34. The locking element 37 is preferably integrated with the intermediate portion 36a of the strip 34. The locking element 37 is configured to be received in a locking element groove 49 of the counter-connecting means 32d of the adjacent building panel 1′.

The locking element 37 includes a locking surface 40 which is configured to lock two connected building panels 1, 1′ in a vertical and/or horizontal direction. The locking surface 40 is configured to lock two building panels 1, 1′ such that they are not able to be horizontally displaced, or move away from each other, in the assembled position. In the illustrated example the locking surface 40 is vertical but may in other embodiment be angled in relation to the horizontal and vertical axis. The locking surface 40 faces in towards the side edge 3b of the building panel 1.

The locking surface 40 is configured to cooperate with a rear locking surface 50 of a locking tongue 45 of the counter-connecting means 32d in the assembled position, as illustrated in the FIG. 5c. The locking surface 40 of the locking element 37 is configured to at least partly be in contact with the rear locking surface 50 of the locking tongue 45, in the assembled position.

The connecting means 32b further includes a tongue groove 60, for a displaceable tongue, arranged in the intermediate portion 6b of the side edge 3b. The tongue groove 60 substantially extends inwards in the horizontal direction. The tongue groove 60 extends inwardly from the vertical plane VP defined by immediately juxtaposed upper portions 5b, 5d of two neighboring joint side edges 3b, 3d of two joined panels 1, 1′ as illustrated in FIG. 5c.

The tongue groove 60, for a displaceable tongue, is arranged in the substrate 10.

The tongue groove 60, for a displaceable tongue, extends, at least partly but preferably continuously, along the extension of the side edge in which it is arranged.

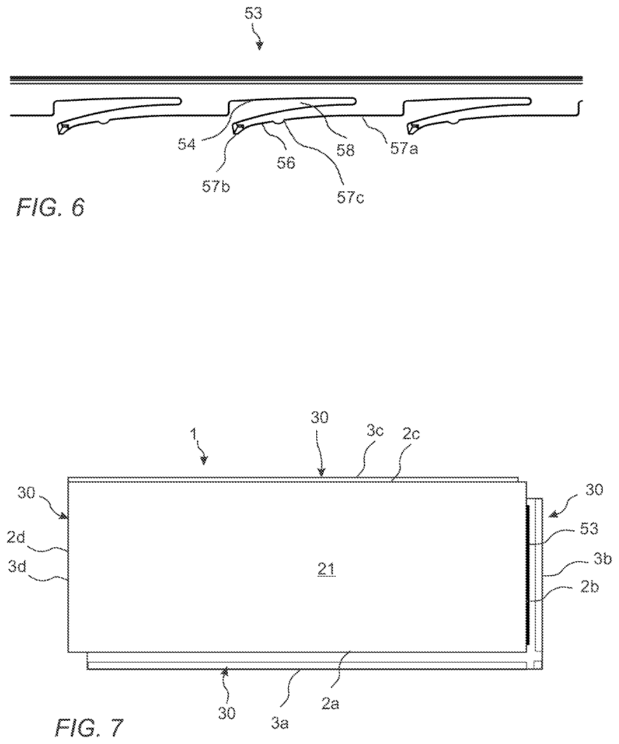

The tongue groove 60 is configured to receive a displaceable locking tongue 53. The displaceable locking tongue 53 is a detachable part which is arranged in the tongue groove 60 before assembling two adjacent building panels 1, 1′. FIG. 6 illustrates such a displaceable locking tongue 53 and FIGS. 5b and 5c illustrate an assembling of two building panels 1, 1′ with the displaceable locking tongue 53. A more detailed description of the displaceable locking tongue is provided below.

The counter-connecting means 32d of the second pair of connecting means, includes a locking element groove 49 which is arranged in the intermediate portion 6d and lower portion 7d of the side edge 3d of the building panel 1. The locking element groove 49 is configured to receive the locking element 37 of the connecting means 32b of the adjacent building panel 1.

The locking element groove 49 extends, at least partly but preferably continuously, along the extension of the side edge in which it is arranged.

The locking element groove 49 includes a front surface 50 which is configured to cooperate, and preferably engage, with the locking surface 40 of the locking element 37 of the adjacent building panel 1 in the assembled position. The front surface 50 is configured to horizontally and/or vertically lock the locking element 37.

The counter-connecting 32d means further includes a displaceable tongue groove 62, which is arranged in the intermediate portion 6d and upper portion 5d of the side edge 3d of the building panel 1. The displaceable tongue groove 62 is configured to receive the displaceable locking tongue 53 in the assembled position. The displaceable tongue groove 62 extends, at least partly but preferably continuously, along the extension of the side edge in which it is arranged.

As described above, the displaceable locking tongue 53 is separate from the rest of the mechanical locking device 30. In the illustrated example of FIG. 6, the displaceable locking tongue 53 has a longitudinal base portion 54 which continuously extends along the length of the displaceable tongue 54. Along the base portion several elongated flexible or bendable parts 56 are provided. The elongated bendable parts 56 are integrated with the base portion 54 at a first end 57a. The opposite second end 57b is configured to move freely between a resting position and an assembled position.

In the resting position, as illustrated in FIG. 6 the elongated bendable parts 56 extend away from the base portion 54, with the second end 57b farthest away from the base portion 54. In between the first end 57a and the second end 57b the elongated body 57c of the bendable part 56 is provided.

Between the elongated bendable part 56 and the base portion 54 there is provided a slot or a gap 58, in the resting position. The bendable part 56 may bend downwards in the slot 58 towards the base portion 54. In an assembled position the bendable parts 56 are bent into the slot 58.

The displaceable locking tongue 53 may be made of any suitable and desirable material as long as the material allows the elongated bendable parts 56 to be bendable. For example, the material may be any type of plastic material, metal-based or wood-based.

Since the locking tongue 53 is displaceable it may, if desirable, be easily removed when building panels are disassembled before being recycled.

The displaceable locking tongue 53 is configured to be received in the tongue groove 60 provided in the side edge 3b of the first building panel 1 and in the tongue groove 62 in the side edge 3d of the second and adjacent building panel 1′. The tongue groove 60, for a displaceable tongue, is provided in the upper portion 5b and/or in the intermediate portion 6b of the side edge 3b. The tongue groove 60 includes an upper wall, a lower wall and an inner wall extending between the lower and upper wall. The base portion 54 is arranged, before assembling two building panels 1, 1′, such that it extends out from the tongue groove 60, for a displaceable tongue, in the connecting means 32b of the first building panel 1. Thus, the bendable parts 56 are arranged facing the inner wall of the tongue groove 60 of the connecting means 32b.

The displaceable locking tongue 53 extends, at least partly but preferably continuously, along the extension of the side edge in which it is arranged.

During the assembling, illustrated in FIGS. 5b and 5c, the locking tongue 45 of the counter connecting means 32d displaces the displaceable locking tongue 53 in the vertical motion downwards, when pushing the second building panel 1′ and its counter connecting means 32d into the connecting means 32b of the first building panel 1. The displaceable locking tongue 53 is pushed into the tongue groove 60, for a displaceable tongue, creating a pretension between the bendable parts 56 of the displaceable locking tongue 53 and the inner wall of the tongue groove 60. Such that when the second building panel 1′ is pushed further down to the first building panel 1 the displaceable locking tongue 52 is flexed back as it reaches the tongue groove 62, for a displaceable tongue, of the second and adjacent building panel 1′.

The displaceable locking tongue 53 is configured to vertically lock two adjacent building panels 1 together.

FIG. 7 illustrate a building panel 1 with the first pair of connecting means are arranged along two opposite sides 2a, 2c of the building panel 1 and the second pair of connecting means, with the displaceable locking tongue 53, are arranged along the two other opposite sides 2b, 2d of the building panel 1.

In the illustrated embodiments the mechanical locking device is integrated with the rest of the building panel, and mainly integrated with the substrate but may also be integrated with the layer arrangement. However, in an alternative embodiment (not shown) the mechanical locking device may be a detachable device configured to be attached or assembled to the rest of the building panel. Such a detachable locking device may preferably be made of a material including the same polymer as the rest of the building panel. If such a detachable locking device is attached to the rest of the building panel by means of an adhesive, the adhesive also includes the same polymer as the detachable locking device and the rest of the building panel.

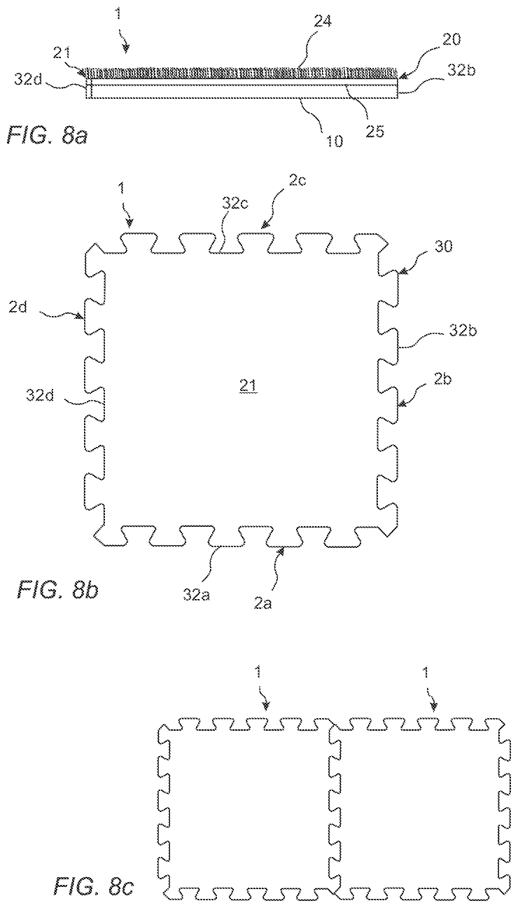

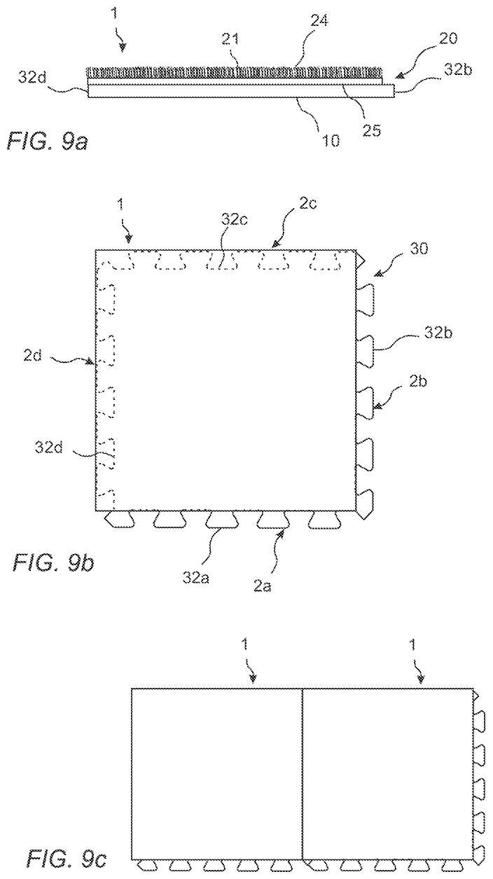

FIGS. 8a-8c and 9a-9c illustrate yet another type building panels 1 with another type of mechanical locking device 30.

The building panels 1 includes, just like described above, a substrate 10 and a layer arrangement 20 arranged on one side of the substrate 10.

The substrate 10 may have a thickness of at least 2 mm, more preferably more than 3 mm, or even more preferably more than 3.5 mm.

The substrate 10 is illustrated as a single layer substrate but may in alternative embodiments be a multi-layer substrate.

Optionally, the building panel may include another layer arrangement (not shown) attached to other opposite side of the substrate. The building panel may then have an upper layer arrangement and a lower layer arrangement, where the upper layer arrangement is arranged on the upper side of the substrate and the lower layer arrangement is arranged on the lower side of the substrate. The optional lower layer arrangement may be configured to serve as a balancing layer for the building panel.

In an embodiment the balancing feature is incorporated in the substrate, e.g., in a multi-layered substrate.

The layer arrangement 20 includes a surface layer 21 which in turn comprises a decorative layer 24 and a carrier 25. The decorative layer is formed by decorative carpet fibres 24. The decorative carpet fibres 24 may be arranged in any suitable known way, as described above, in order to create any desirable pattern, softness or design. The technique and arrangement of the carpet fibres may, throughout an assembled panels system, differ in order to create a desirable design, e.g., different patterns, changing colours, text or other type of design features.

The decorative carpet fibres 24 are attached to the carrier 25 according to any of the known techniques. The carrier 25 may have a uniform, solid shape or a uniform and partly open shape, e.g., a grid-shape. The carpet fibres 24 may then be attached, sewn, or woven into the carrier 25.

The carrier 25 is configured to carry the carpet fibres 24 on one side and be attached to the substrate 10, or any desirable layer arranged between the surface layer 21 and the substrate 10, on the opposite side.

The layer arrangement 20 further includes an adhesive layer arranged between the substrate 10 and the surface layer 21. In the illustrated embodiment the adhesive layer is arranged between the substrate 10 and the carrier 25. The adhesive is configured to adhere the surface layer 21 to the substrate 10, or to any desirable layer arranged between the surface layer 21 and the substrate 10.

The adhesive layer may be or comprise a glue. Alternatively, the adhesive layer may be or comprise a hot melt.

The amount of adhesive applied between the substrate and the rest of the layer arrangement is more than 10 g/m², preferably more than 30 g/m² or even more preferably more than 50 g/m².

In an alternative embodiment, the building panel may comprise an adhering area between the substrate and the layer arrangement. Material from the surface of the substrate, facing the layer arrangement, and the material from the surface of the layer arrangement, e.g., the surface of the carrier, facing the substrate, are at least partly merged with each other in the adhering area. The merge of the surfaces of the substrate and the layer arrangement may be accomplished by a chemical welding process. Alternatively, the merge of the surface of the substrate and the layer arrangement may be accomplished by a hot lamination process.

The substrate 10 and the layer arrangement 20 comprise the same type of polymer, or essentially the same type of polymer. That means that all components and layers of the layer arrangement 20 includes the same type of polymer. Included in the layer arrangement 20 is at least the surface layer 21, i.e., the carpet fibres 24 and the carrier 25, and optionally at least one adhesive layer 28. The polymer is preferably included in a binder of each layer, where the rest of each layer may include, e.g., fillers, pigments, and other additives.

The polymer of the substrate 10 and the layer arrangement 20 may be thermoplastic. The polymer may be a fossil-based polymer, or the polymer may be a bio-based polymer. Bio-based polymers are made from renewable sources such as plants, such as corn-starch or bagasse, algae, bacteria etc.

The polymer of the substrate and the layer arrangement is chosen from polyester, polyvinyl chloride, polypropylene, or polyamide. Thus, the polymer of both the substrate 10 and layer arrangement 20 may either be polyester, or polyvinyl chloride, or polypropylene, or polyamide.

An advantage with these types of polymers is that they are all compatible with each layer, i.e., may be present in substrates, in adhesives, in carpet fibres and carriers, even though these types of different components of a building panel have different properties when it comes to, e.g., design, durability, manufacturing, etc.

The mechanical locking device 30 is essentially formed in the substrate 10 but may in different embodiments be formed in also the layer arrangement 20. The mechanical locking device 30 is configured to lock two adjacent building panels essentially in the horizontal direction.

The mechanical locking device 30 includes connecting means 32a, 32b and counter-connecting means 32c, 32d. The connecting means 32a, 32b are arrange along a first and a second side edge 3a, 3b and configured to engage the counter-connecting means 32c, 32d which are arranged on the opposite third and fourth side edge 3c, 3d.

The building panel 1 illustrated In FIGS. 8a-8b is a building panel 1 where the surface layer 21 follows the contour of the substrate housing the mechanical locking device 30. This means that the engagement between, and the mechanical locking device of two adjacent building panels 1 are visible in the assembled state, as illustrated in FIG. 8c.

The building panel 1 illustrated in FIGS. 9a-9b however, is a building panel 1 where the surface layer 21 is designed to cover the mechanical locking device 30 in an assembled state, such that the engagement between, and the mechanical locking device of two adjacent building panels 1 are hidden in the assembled state, as illustrated in FIG. 9c.

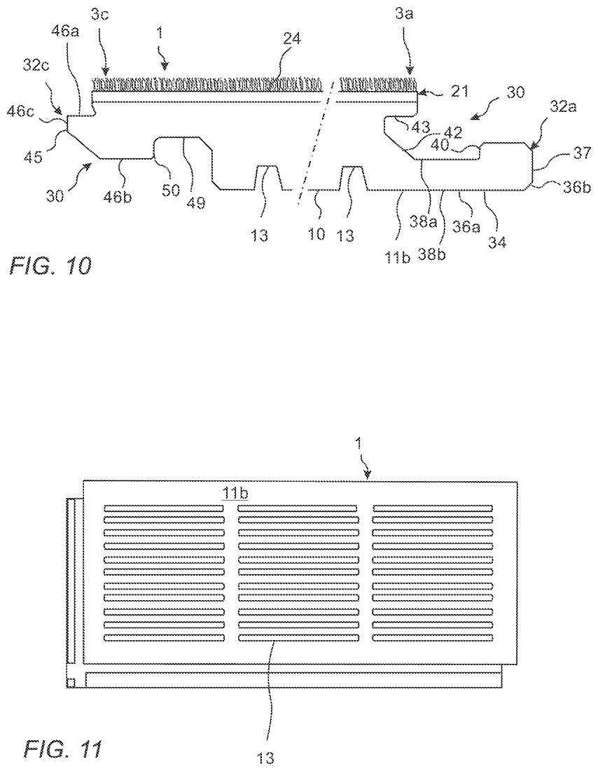

FIGS. 10 and 11 illustrate another possible embodiment of a building panel 1. The building panel 1 is the same as any of the above explained building panels but with the addition that it has a plurality of grooves 13 in the rear surface 11b of the substrate 3. The grooves 13 are preferably arranged in a homogenous pattern and preferably arranged over an area of the rear surface 11b as big as possible. For example, the groove openings may comprise 20 to 80%, such as 40 to 80%, such as 50 to 80% of the rear surface area. The grooves are 13 produced by removing, e.g., by means of a scraping, drilling, or grinding process, material from the rear surface 13 of the substrate 3. An advantage with these grooves 13 is that the weight of the building panel 1 is decreased, which in turn have advantages from an environmental perspective, such as lower transportation weight, or more building panel per weight unit.

FIGS. 12, 13 and 14 are different embodiments of a panel system 70, 70′, 70″ assembled from a plurality of building panels. The different types of illustrated building panels all have the same construction with a substrate and a layer arrangement attached to the substrate, where the entire construction includes the same type of polymer, or essentially the same type of polymer, as explained above. The difference mainly lies in the size and shape of the building panels, but they may also have similar or different types of mechanical locking devices. FIG. 12 illustrates a standard panel system 70 often used within, e.g., flooring. FIG. 13 illustrates a herringbone pattern panel system 70′ assembled by a pluralities of often smaller building panels. FIG. 14 illustrates a panel system 70″ in an installation with a puzzle pattern panel system 70″, where the design of each building panel has a mechanical locking device which essentially locks the adjacent building panels in a horizontal direction.

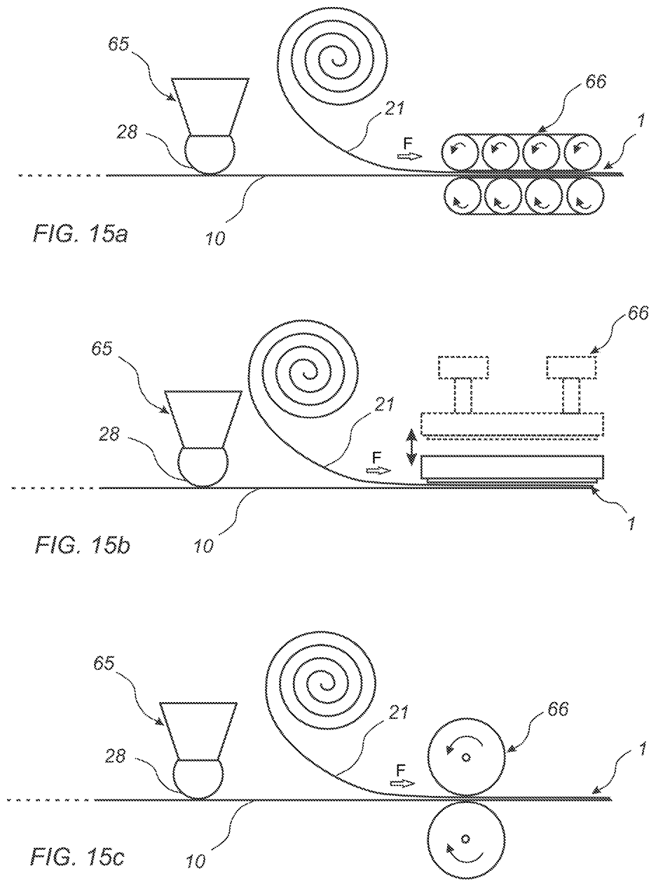

FIGS. 15a-15c schematically illustrate possible methods of producing a building panel 1 as described above. The methods being performed in accordance with the feeding direction F. The method comprising:
providing a substrate 10,
applying a surface layer 21, wherein the surface layer 21 comprises a carrier and carpet fibres, to the substrate 10,
applying an adhesive layer 28 on a surface of the substrate 10 facing the surface layer 21, alternatively (not shown) applying the adhesive layer on a surface of the surface layer facing the substrate, prior to applying the surface layer 21 to the substrate 10,
applying pressure to the substrate 10 and/or the surface layer 21 to form the building panel 1.

The adhesive layer 28 is, in the illustrated examples, applied by means of a rolling device 65. The adhesive may be in a powder form or in a molten form. In another embodiment the adhesive may be applied by a scattering device or any other suitable applicator device. The amount of adhesive applied between the substrate and the rest of the layer arrangement is more than 10 g/m², preferably more than 30 g/m² or even more preferably more than 50 g/m².

The adhesive may be thermoplastic. The adhesive may be a fossil-based polymer, or the adhesive may be a bio-based polymer. Bio-based polymers are made from renewable sources such as plants, such as corn-starch or bagasse, algae, bacteria etc.

The adhesive may be an optional feature and can be replaced by, e.g., a chemical welding process or a hot lamination process to adhere the substrate and the carrier to each other.

The pressure is applied by means of a pressing device 66. The pressing device may be a continuous press, a discontinuous press, or a static press, where the static press is illustrated in FIG. 15b. The pressing device may be a double belt press, as illustrated in FIG. 15a. The pressing device may be a calendaring device, as illustrated in FIG. 15c.

Not illustrated in FIGS. 15a-15c is that the method further comprises:
creating a mechanical locking device 30 in at least the substrate 10, before or after applying pressure to form the building panel 1, where the mechanical locking device 30 is configured to connecting at least two building panels 1.

Creating the mechanical locking device 30 may further comprise partly creating the mechanical locking device in the substrate 10 and partly creating the mechanical locking device in the carrier 25.

Creating the mechanical locking device 30 may further comprise creating a mechanical locking area, in which the mechanical locking device 30 is provided, in the substrate 10 and/or the carrier 25 with a vertical height of at least 2 mm, more preferably more than 3 mm, or even more preferably more than 3.5 mm.

In an alternative method, in the step of applying the adhesive 28, the adhesive 28 may likewise or also be applied on the surface 26b of the carrier 25 facing the substrate 10, before applying the carrier 25 with the surface layer 21 on the substrate 10.

The substrate 10, the adhesive 28, the carrier 25 and the carpet fibres 24 all include the same type of polymer. The substrate 10 and the carrier 25 may comprise a binder including the polymer, whereas the adhesive and the carpet fibres at least partly may comprise the polymer.

The polymer may be thermoplastic.

The polymer may be a fossil-based polymer, or the polymer may be a bio-based polymer. Bio-based polymers are made from renewable sources such as plants, such as corn-starch or bagasse, algae, bacteria etc.

The polymer is preferably chosen from polyester, polyvinyl chloride, polypropylene, or polyamide. Thus, the polymer of the substrate 10, the adhesive 28, the carrier 25 and the carpet fibres 24 may either be polyester, or polyvinyl chloride, or polypropylene, or polyamide.

The adhesive may be a glue or a hot melt.

The method may further comprise:
applying heat to the substrate 10 and/or the surface layer 21 when applying pressure to form the building panel 1.

In an alternative embodiment the method may further comprise:
applying cold to the substrate 10 and/or surface layer 21 when applying pressure to form the building panel 1.

In an alternative method (not shown), the method of producing a building panel may comprise:
providing a substrate,
applying a layer arrangement, where the layer arrangement comprises a surface layer which comprises carpet fibres, on the substrate,
creating adhesion between the substrate and the layer arrangement,
applying pressure to the substrate and/or the layer arrangement to form the building panel,
creating mechanical locking device in at least the substrate, before or after applying pressure to form the building panel.

The mechanical locking device is configured for connecting at least two building panels.

The substrate and the layer arrangement each comprise a binder including the same type of polymer.

Creating adhesion between the substrate and the layer arrangement may comprise merging material from the surface of the substrate facing the layer arrangement and material from the surface of the layer arrangement facing the substrate. Creating adhesion in such a way may be done through a hot lamination process.

Alternatively, merging the material of the substrate and the layer arrangement may be done through a chemical welding process.

Such a chemical welding process may comprise:
applying a solvent on the surface of the substrate, facing the layer arrangement, and/or on the surface of the layer arrangement, facing the substrate, before arranging the layer arrangement on the substrate, to create adhesion between the substrate and layer arrangement. The solvent may be chosen from any one of: Tetrahydrofuran (THF), Acetone and/or Cyclohexane.

Finally, although the inventive concept has been described above with reference to specific embodiments, it is not intended to be limited to the specific form set forth herein. Rather, the invention is limited only by the accompanying claims. Other embodiments than the specific above are equally possible within the scope of the appended claims.

### ITEM SECTION

Item 1. A building panel comprising:
a substrate (10),
a layer arrangement (20), arranged on one side (11a) of said substrate (10),
wherein said layer arrangement (20) comprises a surface layer (21),
wherein said surface layer (21) at least partly comprises carpet fibres (24)
wherein at least said substrate (10) at least partly comprises a mechanical locking device (30) for connecting at least two building panels, and
wherein said substrate (10) comprises a substrate binder, and said layer arrangement (20) comprises a layer arrangement binder, wherein each of the substrate binder and the layer arrangement binder comprise the same type of polymer.

Item 2. The building panel according to item 1, wherein the polymer is the majority polymer in polymer(s) of the substrate binder, and wherein the polymer is the majority polymer in polymer(s) of the layer arrangement binder.

Item 3. The building panel according to item 1 or 2, wherein the polymer of said binder is thermoplastic.

Item 4. The building panel according to any one of the items 1-3, wherein the polymer of said binder is chosen from polyester, polyvinyl chloride, polypropylene, or polyamide.

Item 5. The building panel according to any one of the previous items, wherein the layer arrangement (20) further comprises a carrier (25) to which the carpet fibres (24) are attached, wherein said carrier (25) comprises the same type of polymer as the substrate (10) and the decorative carpet fibres (24).

Item 6. The building panel according to any one of the preceding items, wherein said layer arrangement (20) further comprises an adhesive (28), arranged between the substrate (10) and the surface layer (21), configured to adhere the surface layer (21) to the substrate (10), and wherein said adhesive (28) comprises the same type of polymer as the substrate binder and the layer arrangement binder.

Item 7. The building panel according to item 6, wherein said adhesive (28) is a glue.

Item 8. The building panel according to item 6, wherein said adhesive (28) is a hot melt.

Item 9. The building panel according to any one of the items 1-4, further comprising an adhering area between the substrate (10) and the layer arrangement (20).

Item 10. The building panel according to item 9, wherein material from the surface (11a) of said substrate (10) facing the layer arrangement (20), and material from the surface (26b) of said layer arrangement (20) facing said substrate (10) are at least partly merged with each other in said adhering area.

Item 11. The building panel according to item 10, wherein the merge of the surfaces (11a, 26b) of the substrate (10) and the layer arrangement (20) is accomplished by a chemical welding process.

Item 12. The building panel according to item 10, wherein the merge of the surfaces (11a, 26b) of the substrate (10) and the layer arrangement (20) is accomplished by a lamination process.

Item 13. The building panel according to any one of the preceding items, wherein said carpet fibres (24) are arranged according to a loop pile technique, a cut pile technique, a combination of a loop pile and a cut pile technique, tufted fibres, woven fibres and/or needle punched fibres.

Item 14. The building panel according to any one of the preceding items, wherein the mechanical locking device (30) comprises connecting means (32a, 32b) arranged at least partly along at least one side edge (3a, 3b, 3c, 3d) of said building panel, and counter-connecting means (32c; 32d) arranged at least partly along at least one side edge (3a, 3b, 3c, 3d) of said building panel, wherein said connecting means (32a, 32b) and said counter-connecting means (32c; 32d) are arranged on opposite side edges (3a, 3b, 3c, 3d) of said building panel, and wherein said connecting means (32a, 32b) is configured to engage with a counter-connecting means (32c, 32d) of at least a second building panel.

Item 15. The building panel according to item 13, wherein said connecting means (32a, 32b) and said counter-connecting means (32c, 32d) are configured to lock at least two adjacent building panels in a substantially horizontal and/or vertical direction.

Item 16. A method of producing a building panel comprising:
providing a substrate (10),
applying a surface layer (21) arranged on a carrier (25), wherein said surface layer (21) at least partly comprises carpet fibres (24), on said substrate (10),
applying an adhesive (28) on the surface (11a) of said substrate (10) facing the carrier (25) and/or on the surface (26b) of said carrier (25) facing said substrate (10), before applying said carrier (25) with said surface layer (21) on said substrate (10),
wherein said substrate (10) and said surface layer (21) each comprises a binder comprising the same type of polymer and wherein said adhesive (28) comprises the same type of polymer as the binder/binders,
applying pressure to the substrate (10) and/or said surface layer (21) to form the building panel,
creating a mechanical locking device (30) in at least said substrate (10), before or after applying pressure to form the building panel, wherein said mechanical locking device (30) is configured to connecting at least two building panels.

Item 17. The method according to item 16, wherein the polymer is thermoplastic.

Item 18. The method according to item 16 or 17, wherein the polymer of the substrate (20), the adhesive (28) and the surface layer (21) is chosen from polyester, polyvinyl chloride, polypropylene, or polyamide.

Item 19. The method according to any one of the items 16-18, wherein the adhesive (28) is a glue.

Item 20. The method according to any one of the items 16-18, wherein the adhesive (28) is a hot melt.

Item 21. The method according to any one of the items 16-20, further comprising:
applying heat to the substrate (10) and/or the surface layer (21) when applying pressure to form the building panel.

Item 20. A method of producing a building panel comprising:
providing a substrate (10),
applying a layer arrangement (20), wherein said layer arrangement comprises a surface layer (21) which at least partly comprises carpet fibres (24), on said substrate (10)
creating adhesion between said substrate (10) and said layer arrangement (20),
wherein said substrate (10) and said layer arrangement (20) each comprises a binder comprising the same type of polymer,
applying pressure to the substrate (10) and/or said layer arrangement (20) to form the building panel,
creating a mechanical locking device (30) in at least said substrate (10), before or after applying pressure to form the building panel, wherein said mechanical locking device (30) is configured for connecting at least two building panels.

Item 21. The method according to item 22, wherein creating adhesion between said substrate (10) and said layer arrangement (20) comprises merging material from the surface (11a) of said substrate (10) facing the layer arrangement (20) and material from the surface (26b) of said layer arrangement (20) facing said substrate (10).

Item 24. The method according to items 23, wherein merging the material of said substrate (10) and said layer arrangement (20) is made through a chemical welding process.

Item 23. The method according to items 23, wherein merging the material of said substrate (10) and said layer arrangement (20) is made through a lamination process.

Item 24. A building panel comprising:
a substrate (10), and
a layer arrangement (20), arranged on one side (11a) of said substrate (10),
wherein said layer arrangement (20) comprises a surface layer (21) and wherein said surface layer (21) comprises decorative carpet fibres (24),
wherein at least said substrate (10) comprises a mechanical locking device (30) arranged at least partly along at least one side edge ( ) of said building panel and configured to connect similar or essentially identical building panels in an assembled position, and
wherein said substrate (10) comprises a polymer and said decorative fibres (24) comprises a polymer,
wherein the polymer of the substrate (10) and the polymer of the decorative carpet fibres (24) each are of the same type of polymer,
wherein layer(s) and said decorative carpet fibres (24) included in the layer arrangement (20) each comprises the same type of polymer.

Item 25. The building panel according to item 24, wherein the polymer is the majority polymer in polymer(s) of the substrate, and wherein the polymer is the majority polymer in polymer(s) of the layer(s) and said decorative carpet fibres (24) included in the layer arrangement (20).

Item 26. The building panel according to item 24 or 25, wherein the polymer is a thermoplastic polymer.

Item 27. The building panel according to any one of the items 24-26, wherein the polymer is chosen from polyester, polyvinyl chloride, polypropylene, or polyamide.

Item 28. The building panel according to any one of the items 24-27, wherein the surface layer (21) further comprises a carrier (25) to which the decorative carpet fibres (24) are attached, wherein the carrier (25) comprises a polymer which is the same type of polymer as the substrate (10) and the decorative carpet fibres (24).

Item 29. The building panel according to any one of the items 24-28, wherein said layer arrangement (20) further comprises an adhesive layer (28), arranged between the substrate (10) and the surface layer (21) wherein said adhesive layer (28) comprises the same type of polymer as the substrate (10) and the decorative carpet fibres (24).

Items 30. The building panel according to item 29, wherein said adhesive layer (28) is a glue.

Item 31. The building panel according to item 29, wherein said adhesive layer (28) is a hot melt.

Item 32. The building panel according to any one of the items 24-28, further comprising an adhering area between the substrate (10) and the surface layer (21).

Item 33. The building panel according to item 32, wherein material from the surface (11a) of said substrate (10) facing the surface layer (21), and material from the surface (26b) of said surface layer (21) facing said substrate (10) are at least partly merged with each other in said adhering area.

Item 34. The building panel according to item 33, wherein the merge of the surfaces (11a, 26b) of the substrate (10) and the surface layer (21) is accomplished by a chemical welding process.

Item 35. The building panel according to item 33, wherein the merge of the surfaces (11a, 26b) of the substrate (10) and the surface layer (21) is accomplished by a lamination process.

Item 36. The building panel according to any one of the items 24-35, wherein said decorative carpet fibres (24) are arranged according to a loop pile technique, a cut pile technique, a combination of a loop pile and a cut pile technique, as tufted fibres, woven fibres and/or needle punched fibres.

Item 37. The building panel according to any one of the items 24-36, wherein the mechanical locking device (30) comprises connecting means (32a, 32b) arranged at least partly along at least one side edge (3a, 3b, 3c, 3d) of said building panel, and counter-connecting means (32c; 32d) arranged at least partly along at least one side edge (3a, 3b, 3c, 3d) of said building panel, wherein said connecting means (32a, 32b) and said counter-connecting means (32c; 32d) are arranged on opposite side edges (3a, 3b, 3c, 3d) of said building panel, and wherein said connecting means (32a, 32b) is configured to engage with a counter-connecting means (32c, 32d) of at least a second building panel.

Item 38. The building panel according to item 37, wherein said connecting means (32a, 32b) and said counter-connecting means (32c, 32d) are configured to lock at least two adjacent building panels in a substantially horizontal and/or vertical direction.

1. A building panel comprising:
a substrate, and
a layer arrangement, arranged on one side of said substrate,
wherein said layer arrangement comprises a surface layer and wherein said surface layer comprises decorative carpet fibres,
wherein at least said substrate comprises a mechanical locking device arranged at least partly along at least one side edge of said building panel and configured to connect similar or essentially identical building panels in an assembled position, and
wherein said substrate comprises a substrate binder comprising a polymer and said layer arrangement comprises a layer arrangement binder comprising a polymer,
wherein the polymer of the substrate binder and the polymer of the layer arrangement binder is the same type of polymer,
wherein layer(s) and said decorative carpet fibres of the layer arrangement each comprises the same type of polymer.

2. The building panel according to claim 1, wherein the polymer is a thermoplastic polymer.

3. The building panel according to claim 1, wherein the polymer is chosen from polyester, polyvinyl chloride, polypropylene, or polyamide.

4. The building panel according to claim 1, wherein the surface layer further comprises a carrier to which the decorative carpet fibres are attached, wherein said carrier comprises the same type of polymer as the substrate and the decorative carpet fibres.

5. The building panel according to claim 1, wherein said layer arrangement further comprises an adhesive layer, arranged between the substrate and the surface layer wherein said adhesive layer comprises the same type of polymer as the substrate and the decorative carpet fibres.

6. The building panel according to claim 5, wherein said adhesive layer is a glue.

7. The building panel according to claim 5, wherein said adhesive layer is a hot melt.

8. The building panel according to claim 1, further comprising an adhering area between the substrate and the surface layer.

9. The building panel according to claim 8, wherein material from a surface of said substrate facing the surface layer, and material from a surface of said surface layer facing said substrate are at least partly merged with each other in said adhering area.

10. The building panel according to claim 9, wherein the merge of the surfaces of the substrate and the surface layer is accomplished by a chemical welding process.

11. The building panel according to claim 9, wherein the merge of the surfaces of the substrate and the surface layer is accomplished by a lamination process.

12. The building panel according to claim 1, wherein said decorative carpet fibres are arranged according to a loop pile technique, a cut pile technique, a combination of a loop pile and a cut pile technique, as tufted fibres, woven fibres and/or needle punched fibres.

13. The building panel according to claim 1, wherein the mechanical locking device comprises connecting means arranged at least partly along at least one side edge of said building panel, and counter-connecting means arranged at least partly along at least one side edge of said building panel, wherein said connecting means and said counter-connecting means are arranged on opposite side edges of said building panel, and wherein said connecting means is configured to engage with a counter-connecting means of at least a second building panel.

14. The building panel according to claim 12, wherein said connecting means and said counter-connecting means are configured to lock at least two adjacent building panels in a substantially horizontal and/or vertical direction.

15. A building panel comprising:
a substrate, and
a layer arrangement, arranged on one side of said substrate,
wherein said layer arrangement comprises a surface layer and wherein said surface layer comprises decorative carpet fibres,
wherein at least said substrate comprises a mechanical locking device arranged at least partly along at least one side edge of said building panel and configured to connect similar or essentially identical building panels in an assembled position, and
wherein said substrate comprises a polymer and said decorative fibres comprises a polymer,
wherein the polymer of the substrate and the polymer of the decorative carpet fibres each are of the same type of polymer,
wherein layer(s) and said decorative carpet fibres included in the layer arrangement each comprises the same type of polymer.

16. The building panel according to claim 15, wherein the polymer is a thermoplastic polymer.

17. The building panel according to claim 15, wherein the polymer is chosen from polyester, polyvinyl chloride, polypropylene, or polyamide.

18. The building panel according to claim 15, wherein the surface layer further comprises a carrier to which the decorative carpet fibres are attached, wherein the carrier comprises a polymer which is the same type of polymer as the substrate and the decorative carpet fibres.

19. The building panel according to claim 15, wherein said layer arrangement further comprises an adhesive layer, arranged between the substrate and the surface layer wherein said adhesive layer comprises the same type of polymer as the substrate and the decorative carpet fibres.

20. The building panel according to claim 19, wherein said adhesive layer is a glue.

21. The building panel according to claim 19, wherein said adhesive layer is a hot melt.

22. The building panel according to claim 15, further comprising an adhering area between the substrate and the surface layer.

23. The building panel according to claim 22, wherein material from the surface of said substrate facing the surface layer, and material from the surface of said surface layer facing said substrate are at least partly merged with each other in said adhering area.

24. The building panel according to claim 23, wherein the merge of the surfaces of the substrate and the surface layer is accomplished by a chemical welding process.

25. The building panel according to claim 23, wherein the merge of the surfaces of the substrate and the surface layer is accomplished by a lamination process.

26. The building panel according to claim 15, wherein said decorative carpet fibres are arranged according to a loop pile technique, a cut pile technique, a combination of a loop pile and a cut pile technique, as tufted fibres, woven fibres and/or needle punched fibres.

27. The building panel according to claim 15, wherein the mechanical locking device comprises connecting means arranged at least partly along at least one side edge of said building panel, and counter-connecting means arranged at least partly along at least one side edge of said building panel, wherein said connecting means and said counter-connecting means are arranged on opposite side edges of said building panel, and wherein said connecting means is configured to engage with a counter-connecting means of at least a second building panel.

28. The building panel according to claim 27, wherein said connecting means and said counter-connecting means are configured to lock at least two adjacent building panels in a substantially horizontal and/or vertical direction.

29. A method of producing a building panel comprising:
providing a substrate,
applying a surface layer, comprising a carrier and decorative carpet fibres, on said substrate,
applying an adhesive layer on a surface of said substrate facing the surface layer and/or on a surface of said surface layer facing said substrate, before applying said surface layer on said substrate,
wherein said substrate, said adhesive layer, said surface layer comprising said carrier and said decorative carpet fibres, comprise the same type of polymer,
applying pressure to form the building panel,
creating a mechanical locking device in at least said substrate at least partly along at least one side edge of said building panel before or after applying pressure to form the building panel, wherein said mechanical locking device is configured to connect similar or essentially identical building panels in an assembled position.

30. The method according to claim 29, wherein the polymer is a thermoplastic polymer.

31. The method according to claim 29, wherein the polymer of each of the substrate, the adhesive layer, the carrier and the decorative carpet fibres is chosen from polyester, polyvinyl chloride, polypropylene, or polyamide.

32. The method according to claim 29, wherein the adhesive layer is a glue.

33. The method according to claim 29, wherein the adhesive layer is a hot melt.

34. The method according to claim 29, further comprising:
applying heat to the substrate and/or the surface layer when applying pressure to form the building panel.

35. A method of producing a building panel comprising:
providing a substrate,
applying a layer arrangement, wherein said layer arrangement comprises a surface layer which comprises decorative carpet fibres, on said substrate
creating adhesion between said substrate and said layer arrangement,
wherein said substrate, said layer arrangement, comprising said surface layer which comprises said decorative carpet fibres, comprise the same type of polymer,
applying pressure to the substrate and/or said layer arrangement to form the building panel,
creating a mechanical locking device in at least said substrate at least partly along at least one side edge of said building panel, before or after applying pressure to form the building panel, wherein said mechanical locking device is configured to connect similar or essentially identical building panels in an assembled position.

36. The method according to claim 35, wherein creating adhesion between said substrate and said layer arrangement comprises merging material from the surface of said substrate facing the layer arrangement and material from the surface of said layer arrangement facing said substrate.

37. The method according to claims 36, wherein merging the material of said substrate and said layer arrangement is made through a chemical welding process.

38. The method according to claims 36, wherein merging the material of said substrate and said layer arrangement is made through a lamination process.
